(19) United States
(12) Patent Application Publication
(10) Pub. No.: US 2012/0185309 A1
(43) Pub. Date: Jul. 19, 2012

(54) METHOD AND SYSTEM FOR AUTOMATICALLY GENERATING EVENT RELEVANT MARKETING DEVICES

(76) Inventors: Kashinath Kakarla, Bangalore (IN); Vishnu Nanda, Bangalore (IN); Anup P. Mutalik, Bangalore (IN); Sagar Dutta, Bangalore (IN); Chinmay Garde, Maharashtra (IN); Sharath H. Upadhya, Bangalore (IN)

(21) Appl. No.: 13/009,705

(22) Filed: Jan. 19, 2011

(51) Int. Cl. G06Q 30/00

(52) U.S. Cl. 705/14.5; 705/14.66; 705/14.53; 705/14.64

(57) ABSTRACT

A method and system for automatically generating event relevant marketing devices whereby events data is obtained from one or more sources that indicates upcoming events of interest to a merchant. Offer data to be associated with a marketing device is obtained from the merchant. The offer data, and/or the merchant submitting the offer data, indicates the merchant, and/or services offered by merchant, and/or products offered by merchant. The offer data is then mapped to one or more event types using a merchant/product/service type-to-event type mapping system and the events data is searched to identify a relevant event represented by the events data that is of the event type mapped to the offer data. The offer data and the portion of the events data representing the identified relevant event is then “matched” and used to automatically generate one or more event relevant marketing devices that include at least part of the matched offer data and at least part of the matched relevant event data.

### BACKGROUND

Many small business owners, such as providers of consumer products and services, and other advertisers, herein collectively referred to as “merchants”, offer marketing devices, such as promotional and/or discount offers, price guarantee offers, bundled offers, coupons, and vouchers, to consumers in an effort to attract and/or encourage business.

Traditionally, marketing devices were distributed in “hard-copy”, or printed, form, by various means, including, but not limited to: by mail; in newspapers; in magazines; in flyers and inserts; at store fronts and/or product displays; and/or as attachments to store receipts (i.e., printed on the back of a receipt or appended to a receipt).

More recently, marketing devices have been offered/distributed as “electronic media based marketing devices” using electronic means such as, but not limited to: networks of computing systems, including public networks such as the Internet; mobile networks and computing systems, such as smart phones; various advertising/coupon web-sites; e-mail; electronic coupon attachments to electronic receipts; and electronic coupon attachments to transactional data, such as, but not limited to, transactional data from and/or displayed by, banks, credit card companies, and other financial institutions.

Even more recently, “mobile coupons” have become increasingly popular. Using mobile coupons, a marketing device is provided that is a type of electronic media based marketing device made available to, and/or delivered to, a consumer via a display device on one or more mobile computing systems, or other mobile devices. In many instances, once a mobile coupon is made available, or delivered, to the consumer via the display device, the mobile coupon is also presented to a seller of products and/or services, and/or is used, by displaying the mobile coupon to a merchant via the display device on the one or more mobile computing systems, or other mobile devices, or by another form of data transfer.

In addition, in many parts of the world, marketing devices, including mobile coupons, are now distributed via non-Internet based communication channels, such as communications networks supporting Short Message Service (SMS) communications and/or in SMS messages.

In order to most efficiently use their marketing and/or advertising resources, merchants, and particularly small business owners/operators, typically want to ensure their marketing devices are distributed to “real potential customers”, i.e., consumers who are most likely to be motivated by the marketing device to make a purchase of a given product and/or service.

In addition, consumers typically want to ensure that any marketing devices they receive are useful to the consumer and are made available to the consumer in a timely manner, i.e., when the consumer is likely to want to use the marketing device.

One way a merchant could theoretically help ensure his marketing devices are relevant to the receiving consumers would be to link the marketing device to one or more “events” such as local holidays, festivals, sporting matches, concerts, entertainment events, etc., in which the consumer is likely to take part or follow. However, it is currently extremely time consuming for a merchant to create marketing devices that are customized, or relevant, to one or more events, i.e., to generate event relevant marketing devices.

This is because in order to create event relevant marketing devices using currently available methods and systems, the merchant must, largely manually: determine what events are coming up in one or more areas/regions associated with the merchant's business; determine which of the upcoming events are logically related, or relevant, to the merchant's products and/or services and/or the offer of any marketing device; determine what consumers might be involved with, affected by, and/or interested in, the determined relevant events; determine what offer to include with any marketing device, i.e. the terms of the offer; choose a distribution mechanism; create the actual marketing device wording and ensure the marketing device wording meets any formatting requirements for the selected distribution mechanism, such as SMS character limits and formatting, in one or more languages; translate the marketing device, if necessary, into one or more languages associated with the areas where the determined relevant events are taking place; track the dates and/or times of the determined relevant events; make a determination of the best time to distribute the marketing devices to correlate the marketing devices to the dates and/or times of the determined relevant events; and then distribute the marketing devices, in the one or more relevant languages, and in the proper format for the chosen communication channel, to the consumers that the merchant determined might be involved with, affected by, and/or interested in, the determined relevant events.

As seen above, using currently available methods and systems, a significant amount of merchant time is required to create event relevant marketing devices, as well as, significant other resources such as local calendars, event postings, media announcements, etc. In addition, since marketing, and generating marketing devices, is not likely to be the merchant's business or area of expertise, there is no guarantee that the merchant will make all, or any, of the determinations discussed above correctly, or effectively. Consequently, even if the merchant devotes the required resources, the resulting marketing devices may still not be particularly effective, or yield any tangible results.

As a result, currently, very few merchants, and particularly few small business owners/operators, actually do commit the resources to create event relevant marketing devices and, therefore, relatively few event relevant marketing devices are currently generated, especially by small business owners/operators. This is particularly true in regions where SMS is the chosen, or only, communication/distribution channel for marketing devices. Consequently, currently, many merchants, and consumers, are denied the opportunity to receive highly relevant marketing devices at times when they would be of most use to the consumer. Clearly, this is a far from ideal situation for both the merchants and the consumers.

### SUMMARY

In accordance with one embodiment, a method and system for automatically generating event relevant marketing devices includes a process for automatically generating event relevant marketing devices whereby, in one embodiment, a merchant/product/service type-to-event type mapping system is created that, in one embodiment, uses keywords, or other data, to map, and/or match, merchants, and/or services offered by merchants, and/or products offered by merchants, to types of events that are potentially related to, and/or are associated with, and/or logically connected to, the merchants, services, and/or products. In one embodiment, events data is obtained from one or more sources that indicates upcoming events such as, but not limited to, holidays, festivals, sporting matches, races, and/or entertainment-based engagements, associated with one or more areas, and/or regions, of interest to a merchant. In one embodiment, offer data to be associated with a marketing device, such as the business location, products and/or services subject to the offer, discounts and/or prices offered, any other relevant terms of the offer, and/or any possible events the merchant desires to connect with the offer, is obtained from the merchant. In one embodiment, the offer data, and/or the merchant submitting the offer data, indicates the merchant, and/or services offered by merchant, and/or products offered by merchant. In one embodiment, the offer data is mapped to one or more event types using the merchant/product/service type-to-event type mapping system. In one embodiment, the events data is searched to identify a relevant event represented by the events data that is of the event type mapped to the offer data. In one embodiment, the offer data and the portion of the events data representing the identified relevant event are “matched”. In one embodiment, the matched offer data and relevant event data is automatically transformed into one or more event relevant marketing devices that include at least part of the matched offer data and at least part of the matched relevant event data. In one embodiment, the one or more event relevant marketing devices are presented to the user/merchant for selection, review, and/or approval. In one embodiment, the selected/approved one or more event relevant marketing devices are then distributed to one or more consumers, in one embodiment, at a time calculated to correlate with the matched relevant event.

In one embodiment, the one or more consumers to whom the selected/approved one or more event relevant marketing devices are distributed are themselves selected by matching consumer profile data associated with the one or more consumers to the relevant event data and/or offer data.

Using the method and system for automatically generating event relevant marketing devices, as discussed herein, in response to a user merchant providing only a minimal amount of data, i.e., the offer data, one or more event relevant marketing devices are automatically generated, and sent to relevant consumers, on behalf of the user merchant.

This is possible because, in one embodiment: the determination of what events are coming up in one or more areas/regions associated with the merchant's business; the determination of which of the upcoming events are logically related, or relevant, to the merchant's products and/or services and/or the offer of the marketing device; the creation of the actual marketing device wording and ensuring the marketing device wording meets any formatting requirements for one or more distribution mechanisms, such as SMS character limits and formatting, in one or more languages; the translation of the marketing device, if necessary, into one or more languages associated with the areas where the determined relevant events are taking place; the tracking of the dates and/or times of the determined relevant events; the determination of the best time to distribute the marketing devices to correlate the marketing devices to the dates and/or times of the determined relevant events; and, in one embodiment, the determination of what consumers might be involved with, affected by, and/or interested in, the determined relevant events, is performed automatically by the method and system for automatically generating event relevant marketing devices, in the background, and then the generated marketing devices are automatically distributed one or more consumers in a timely manner.

Therefore, using the method and system for automatically generating event relevant marketing devices, as discussed herein, more merchants, and particularly more small business owners/operators, will be able to distribute event relevant marketing devices thereby providing both merchants and consumers the opportunity to use highly relevant marketing devices at times when they will be of most use to the consumer.

As discussed in more detail below, using the below embodiments, with little or no modification and/or user/consumer input, there is considerable flexibility, adaptability, and opportunity for customization to meet the specific needs of various users/consumers under numerous circumstances.

### BRIEF DESCRIPTION OF THE DRAWINGS

FIG. 1 is a block diagram of an exemplary hardware architecture for implementing one embodiment;

FIG. 2 is a flow chart depicting a process for automatically generating event relevant marketing devices in accordance with one embodiment; and

FIG. 3 is a flow chart depicting a process for automatically generating event relevant marketing devices in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be embodied in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a process for automatically generating event relevant marketing devices begins with the creation of a merchant/product/service type-to-event type mapping system.

In on embodiment, the merchant/product/service type-to-event type mapping system uses keywords, or other data, to map, and/or match, merchants, and/or services offered by merchants, and/or products offered by merchants, to types of events that are potentially related to, and/or are associated with, and/or logically connected to, the merchants, services, and/or products.

In one embodiment, the merchant/product/service type-to-event type mapping system is a mapping table, look-up-table, or other mapping system, created to link a given business type, product type, or service type to one or more appropriate, or logically related, event types.

As a specific example, a merchant or business type known to be associated with selling jewelry, or including the keyword “jewelry” in the description of its products, might be mapped, or linked, to the events “Valentine's Day”, and/or “Christmas”, and/or “graduation”, or the keywords “wife”, and/or “engagement” and/or “graduation” using one embodiment of the merchant/product/service type-to-event type mapping system. However, a merchant or business type known to be associated with selling jewelry, or including the keyword “jewelry” in the description of its products, would not likely be mapped, or linked to, event types involving sports, or key words associated with various sporting events.

On the other hand, a merchant or business type known to be associated with selling food, and/or alcohol, or including the keyword “pizza” or “beer” in the description of its products, might well be mapped, or linked, to event types involving sports, or key words associated with various sporting events using one embodiment of a merchant/product/service type-to-event type mapping system.

The actual mapping performed by the merchant/product/service type-to-event type mapping system and/or the keywords, or other data used, to map, and/or match, merchants, and/or services offered by merchants, and/or products offered by merchants, to types of events that are potentially related to, and/or are associated with, and/or logically connected to, the merchants, services, and/or products, will vary significantly from region-to-region. In addition, procedures for creating and implementing mapping functions, and matching engines, in general are known. Consequently, a more specific discussion of specific implementations of the merchant/product/service type-to-event type mapping system is omitted here to avoid detracting from the invention.

In one embodiment, events data is obtained from one or more sources. In one embodiment, the events data is obtained from any one or more of, but not limited to, the following sources: local, regional, and/or national calendars; religious calendars; local and regional newspapers and other printed media; local, regional and/or government sources; sporting organizations and/or sporting organization calendars; one or more sports teams and/or team calendars; local, regional, and/or national radio and/or TV stations; local, regional, and/or national web-sites; the Internet; blogs and/or social media sites; subscription services; subscribers; and/or any other source of events, events calendars, and event dates, as discussed herein, and/or as known in the art at the time of filing, and/or as developed after the time of filing.

In various embodiments, the events data indicates various events, and/or event dates and times, such as, but not limited to: religious holidays; religious festivals; secular holidays; secular festivals; regional holidays; regional festivals; sporting matches; races; entertainment-based engagements, such concerts; or any other events that are likely to attract consumers and/or consumers' attention, associated with one or more areas, and/or regions, of interest to a merchant.

In various embodiments, the events data is then stored.

In one embodiment, offer data to be associated with a marketing device is obtained. In one embodiment, the offer data is obtained from a merchant. In one embodiment, the offer data is obtained from a merchant via a computing system. In one embodiment, the offer data is obtained from a merchant via a mobile computing system, such as a mobile phone. In one embodiment, the offer data is obtained from a merchant via a Short Message Service (SMS) message sent via an SMS capable communications network and an SMS capable system. In one embodiment, the offer data is obtained from a merchant via a user interface display and designated text fields and/or in a designated text format.

In one embodiment, the offer data is obtained using any means, method, process, and/or procedure, and/or any combination of means, methods, processes, and/or procedures, of obtaining data, as discussed herein, and/or as known in the art at the time of filing, and/or as developed after the time of filing.

In one embodiment, the offer data includes, but is not limited to, any one or more of: the name of the merchant and/or the merchant's business; the products sold by the merchant and/or the merchant's business; the services provided by the merchant and/or the merchant's business; the products and/or services that are the subject of the offer data; the terms of the offer, such as discount, price, bundled products, etc.; any conditions of the offer, i.e., expiration dates, restrictions on use, bundled products, etc.; any events or events types the merchant feels are good candidates to link with the offer data; and/or any other offer data the merchant desires to provide and/or is required by the provider of the process for automatically generating event relevant marketing devices.

In one embodiment, the offer data, and/or the merchant submitting the offer data, must indicate, at a minimum, the merchant/business, and/or at least some of the services and/or products offered by the merchant/business.

In one embodiment, the offer data is then stored.

In one embodiment, at least part of the offer data is mapped to one or more event types using the merchant/product/service type-to-event type mapping system as discussed above.

In one embodiment, at least part of the offer data is mapped to one or more event types using the merchant/product/service type-to-event type mapping system under the direction of one or more processors associated with one or more computing systems.

In one embodiment, the events data is then searched to identify at least one relevant event represented by the events data that is of the event type mapped to the offer data.

In one embodiment, the events data is the searched to identify at least one relevant event represented by the events data that is of the event type mapped to the offer data using one or more processors associated with one or more computing systems.

In one embodiment, the offer data and the portion of the events data representing the identified relevant event are “matched”, and/or linked.

In one embodiment, the offer data and the portion of the events data representing the identified relevant event are “matched”, and/or linked under the direction of one or more processors associated with one or more computing systems.

In one embodiment, the matched offer data and relevant event data is used to automatically generate at least one event relevant marketing device that includes at least part of the matched offer data and at least part of the matched relevant event data.

In one embodiment, the matched offer data and relevant event data is used to automatically generate at least one event relevant marketing device that includes at least part of the matched offer data and at least part of the matched relevant event data by one or more processors associated with one or more computing systems.

In one embodiment, at least one event relevant marketing device that includes at least part of the matched offer data and at least part of the matched relevant event data is presented to the user merchant for review and/or approval and/or editing.

In one embodiment, at least one event relevant marketing device that includes at least part of the matched offer data and at least part of the matched relevant event data is presented to the user merchant for review and/or approval and/or editing on a merchant computing system.

In one embodiment, the matched offer data and relevant event data is used to automatically generate at least two event relevant marketing devices that include at least part of the matched offer data and at least part of the matched relevant event data and the two or more event relevant marketing devices are presented to the user/merchant for selection of one of the marketing offers and/or review and/or approval and/or editing.

In one embodiment, the matched offer data and relevant event data is used to automatically generate at least two event relevant marketing devices that include at least part of the matched offer data and at least part of the matched relevant event data and the two or more event relevant marketing devices are presented to the user/merchant for selection of one of the marketing offers and/or review and/or approval and/or editing on a merchant computing system.

In one embodiment, the selected/approved one or more event relevant marketing devices are then distributed to one or more consumers, in one embodiment, at a time calculated to correlate with the matched relevant event.

In one embodiment, the selected/approved one or more event relevant marketing devices are distributed to one or more consumers at one or more computing systems associated with the one or more consumers.

In one embodiment, the selected/approved one or more event relevant marketing devices are distributed to one or more consumers via one or more computing systems associated with the one or more consumers.

In one embodiment, the selected/approved one or more event relevant marketing devices are distributed to one or more consumers via one or more mobile computing systems, such as mobile phones, associated with the one or more consumers.

In one embodiment, the selected/approved one or more event relevant marketing devices are distributed to one or more consumers via one or more Short Message Service (SMS) messages sent via one or more SMS capable communications networks and one or more SMS capable systems associated with the one or more consumers.

In one embodiment, the one or more consumers to whom the selected/approved one or more event relevant marketing devices are distributed are themselves selected by matching consumer profile data associated with the one or more consumers to the relevant event data and/or offer data.

In one embodiment, consumer profile data is obtained for one or more consumers. In one embodiment, the consumer profile data is obtained from any one or more of, but not limited to: the consumers themselves; computing systems associated with the consumers; mobile computing systems associated with the consumers; data collected by monitoring a consumers historical usage of marketing devices, including event relevant marketing devices; and/or any other source of consumer profile data, or combination of sources of consumer profile data, as discussed herein, and/or as known in the art at the time of filing, and/or as developed after the time of filing.

In one embodiment, the consumer profile data includes, but is not limited to any one or more of: general demographic data associated with the consumer such as region of residence and/or employment, sex, religious beliefs/affiliations, etc.; the consumer's hobbies and/or interests, such as sports played/followed, entertainment preferences, etc.; the consumer's age; the consumer's occupation; the consumer's marital status; the consumer's number of dependents; and/or any other consumer profile data the consumer cares to provide and/or as is desired.

In one embodiment, the consumers' profile data is searched to find matches between one or more consumers' profile data and the matched offer data and/or matched relevant event data.

In one embodiment, the consumers' profile data is searched to find matches between one or more consumers' profile data and the matched offer data and/or matched relevant event data using one or more processors associated with one or more computing systems.

In one embodiment, one or more matched consumers whose profile data matches the matched offer data and/or matched relevant event data are identified.

In one embodiment, one or more matched consumers whose profile data matches the matched offer data and/or matched relevant event data are identified using one or more processors associated with one or more computing systems.

In one embodiment, the selected/approved one or more event relevant marketing devices are then distributed to the one or more matched consumers, in one embodiment, at a time calculated to correlate with the matched relevant event.

In one embodiment, the selected/approved one or more event relevant marketing devices are distributed to the one or more matched consumers at one or more computing systems associated with the one or more matched consumers.

In one embodiment, the selected/approved one or more event relevant marketing devices are distributed to the one or more matched consumers via one or more computing systems associated with the one or more matched consumers.

In one embodiment, the selected/approved one or more event relevant marketing devices are distributed to the one or more matched consumers via one or more mobile computing systems, such as mobile phones, associated with the one or more matched consumers.

In one embodiment, the selected/approved one or more event relevant marketing devices are distributed to the one or more matched consumers via one or more Short Message Service (SMS) messages sent via one or more SMS capable communications networks and one or more SMS capable systems associated with the one or more matched consumers.

As a specific illustrative example, in one embodiment, assume a merchant/product/service type-to-event type mapping system is created that maps a merchant whose products description includes the keyword “pizza” with sporting events having keywords such as “baseball”, “football”, “cricket”, and “basketball”.

In this specific illustrative example, assume events data is obtained that indicates a major cricket match scheduled for Sunday, May 3 at 7 P.M.

In this specific illustrative example, assume a merchant sells pizza and submits the following offer data via SMS:
Item: Large Vegie Pizza
Offer: 10%, free coke

In this specific illustrative example, the offer data keyword “pizza” would be mapped to the events including the keywords “baseball”, “football”, “cricket”, and “basketball” using the merchant/product/service type-to-event type mapping system.

In this specific example, the events data is searched to identify a relevant event, a “cricket” event represented by the events data that is of the event type mapped to the offer data and, in this case the major cricket match scheduled for Sunday, May 3.

In this specific example, the offer data, i.e., the keyword “pizza”, and the portion of the events data representing the identified relevant event, i.e., the keyword “cricket” in the events data indicating the major “cricket” match scheduled for Sunday, May 3 is “matched”.

In this specific example, the matched offer data and relevant event data is automatically transformed into one or more event relevant marketing devices that include at least part of the matched offer data and at least part of the matched relevant event data. In this specific example, the one or more event relevant marketing devices could include the following event relevant marketing devices:
1. Invite your friends for today's major cricket match between RCB and DC, order a Vegie Pizza @10% off and free coke. Call 989898989898
2. Order a Veggie Pizza 10% off with free coke; take a break from cooking watch RCB vs. DC @ 7 P.M. tonight.

In this specific example, the merchant would choose one of the event relevant marketing devices above for distribution.

In one embodiment, in this specific example, consumers' profile data is searched to find matches between one or more consumers' profile data and the matched offer data and/or matched relevant event data. For instance, the consumers' profile data could be searched for keywords such as “pizza” or “cricket”, or both “pizza” or “cricket”. In this specific example, assume two or more consumers are matched to the keywords “pizza” and “cricket”. Then these consumers are identified as matched consumers.

In one embodiment, the selected event relevant marketing device is then distributed to the identified matched consumers. In this specific example, the selected/approved event relevant marketing device is distributed to the matched consumers via a Short Message Service (SMS) message sent via one or more SMS capable communications networks and one or more SMS capable systems associated with the matched consumers.

As another specific illustrative example, in one embodiment, assume a merchant/product/service type-to-event type mapping system is created that maps a merchant whose products description include the keywords “fine dining” and “dinner” with events such as “Valentine's Day” or “Thanksgiving”.

In this specific illustrative example, assume events data is obtained that indicates a Valentine's Day is scheduled for Monday, February 14.

In this specific illustrative example, assume a merchant is the owner of a restaurant and submits the following offer data via SMS:
Item: dinner
Offer: 10% off

In this specific illustrative example, the offer data keyword “dinner” would be mapped to the events including “Valentine's day” and “Thanksgiving” using the merchant/product/service type-to-event type mapping system.

In this specific example, the events data is searched to identify a relevant event, i.e., “Valentine's Day” represented by the events data that is of the event type mapped to the offer data.

In this specific example, the offer data, i.e., the keyword “dinner”, and the portion of the events data representing the identified relevant event, i.e., “Valentine's Day” and Monday, February 14, is “matched”.

In this specific example, the matched offer data and relevant event data is automatically transformed into one or more event relevant marketing devices that include at least part of the matched offer data and at least part of the matched relevant event data. In this specific example, the one or more event relevant marketing devices could include the following event relevant marketing devices:
1. This Valentine's day enjoy a quite dinner with family at Nandinis @ 10% off on the bill.
2. This Monday have a blast @ Nandinis, get 10% discount on showing student ID card.

In this specific example, the merchant would choose one of the event relevant marketing devices above for distribution.

In one embodiment, in this specific example, consumers' profile data is searched to find matches between one or more consumers' profile data and the matched offer data and/or matched relevant event data. For instance, the consumers' profile data could be searched for keywords such as “married” or “engaged”. In this specific example, assume two or more consumers are matched to the keywords “married” and “engaged”. Then these consumers are identified as matched consumers.

In one embodiment, the selected event relevant marketing device is then distributed to the identified matched consumers, in this specific example, the event relevant marketing device is then distributed on Monday, February 7, to allow the consumers time to make a reservation. In this specific example, the selected/approved event relevant marketing device is distributed to the matched consumers via a Short Message Service (SMS) message sent via one or more SMS capable communications networks and one or more SMS capable systems associated with the matched consumers.

As another specific illustrative example, in one embodiment, assume a merchant/product/service type-to-event type mapping system is created that maps a merchant whose products description include the keywords “jaggery” and “sesame” with the event “Sankranthi”, a festival celebrated in India.

In this specific illustrative example, assume events data is obtained that indicates “Sankranthi” is scheduled for Jan. 14, 2011.

In this specific illustrative example, assume a merchant sells “jaggery” and “sesame” and submits the following offer data via SMS, in English:
Item: jaggery, sesame
Offer: 10%

In this specific illustrative example, the offer data keywords “jaggery” and “sesame” would be mapped to the events including “India”, and/or “Festival”, and/or “Sankranthi” using the merchant/product/service type-to-event type mapping system.

In this specific example, the events data is searched to identify a relevant event, i.e., “Sankranthi” represented by the events data that is of the event type mapped to the offer data.

In this specific example, the offer data, i.e., the keywords “jaggery” and “sesame”, and the portion of the events data representing the identified relevant event, i.e., “Sankranthi” and Jan. 14, 2011, is “matched”.

In this specific example, the matched offer data and relevant event data is automatically transformed into one or more event relevant marketing devices that include at least part of the matched offer data and at least part of the matched relevant event data. However, in this specific example, even though the offer data was submitted in English, since the Sankranthi festival is celebrated in India, the relevant marketing devices are generated in Hindi and, in this specific example, the one or more event relevant marketing devices could include the following event relevant marketing devices:
nimma sankrantiyannu kushiyinda aacharisi! yellu bellada mele 10% riyAyiti paDeyiri.
Telugu: meeru sankrantini santoshanga jarupukodAniki meeku nuvvulu mariyu bellam pai 10% riyAyiti poNdanDi.

In this specific example, the merchant would choose one of the event relevant marketing devices above for distribution.

In one embodiment, in this specific example, consumers' profile data is searched to find matches between one or more consumers' profile data and the matched offer data and/or matched relevant event data. For instance, the consumers' profile data could be searched for keywords such as “India” or “Indian” or “Hindi” or “Hindu”. In this specific example, assume two or more consumers are matched to the keywords “India” and “Hindi”. Then these consumers are identified as matched consumers.

In one embodiment, the selected event relevant marketing device is then distributed to the identified matched consumers, in this specific example, the event relevant marketing device is then distributed on January 13 and 14, to serve the dual purposes of reminding the consumers about the offer and the festival. In this specific example, the selected/approved event relevant marketing device is distributed to the matched consumers via a Short Message Service (SMS) message sent via one or more SMS capable communications networks and one or more SMS capable systems associated with the matched consumers.

Using the process for automatically generating event relevant marketing devices, as discussed herein, in response to a user merchant providing only a minimal amount of data, i.e., the offer data, one or more event relevant marketing devices are automatically generated, and sent to relevant consumers, on behalf of the user merchant.

Therefore, using the process for automatically generating event relevant marketing devices, as discussed herein, more merchants, and particularly more small business owners/operators, will be able to distribute event relevant marketing devices thereby providing both merchants and consumers the opportunity to use highly relevant marketing devices at times when they will be of most use to the consumer.

### Hardware System Architecture

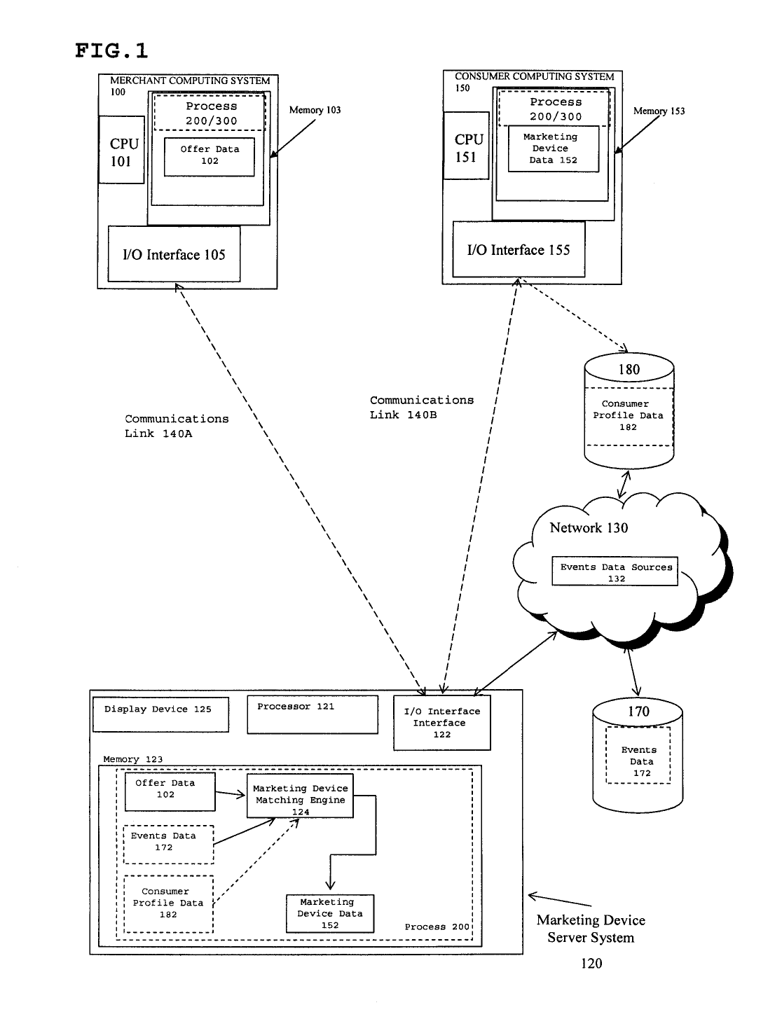

FIG. 1 is a block diagram of an exemplary hardware architecture for implementing one embodiment of a system and method for automatically generating event relevant marketing devices, such as exemplary process 200, discussed herein, that includes: a merchant computing system 100, e.g., a first computing system; a consumer computing system 150, e.g., a second computing system; a marketing device server system 120, e.g., a third computing system; a consumer profile database 180, e.g., a first database; an events data database 180, e.g., a second database; events data sources 132; a communications link 140A, e.g., a first communications link; a communications link 140B, e.g., a second communications link; and a network 130.

As seen in FIG. 1, merchant computing system 100 typically includes a central processing unit (CPU) 101, an input/output (I/O) interface 105, and a memory system 103. In one embodiment, memory system 103 includes all, or part of, a process for automatically generating event relevant marketing devices 200. In one embodiment, process for automatically generating event relevant marketing devices 200 is stored, in whole, or in part, in memory system 103.

In one embodiment, memory system 103 includes all, or part of, offer data 102. In one embodiment, offer data 102 includes, but is not limited to, any one or more of: the name of the merchant and/or the merchant's business; the products sold by the merchant and/or the merchant's business; the services provided by the merchant and/or the merchant's business; the products and/or services that are the subject of the offer data; the terms of the offer, such as discount, price, bundled products, etc.; any conditions of the offer, i.e., expiration dates, restrictions on use, bundled products, etc.; any events or events types the merchant feels are good candidates to link with the offer data; and/or any other offer data the merchant desires to provide and/or is required by the provider of the process for automatically generating event relevant marketing devices.

In one embodiment, the offer data, and/or the merchant submitting the offer data, must indicate, at a minimum, the merchant/business, and/or at least some of the services and/or products offered by the merchant/business.

Merchant computing system 100 may further include standard consumer interface devices such as a keyboard (not shown), a mouse (not shown), a printer (not shown), and a display device (not shown), as well as, one or more standard input/output (I/O) devices (not shown), such as a compact disk (CD) or Digital Video Disc (DVD) drive, floppy disk drive, or other device capable of inputting data to, and outputting data from, merchant computing system 100, whether available or known at the time of filing or as later developed.

In one embodiment, process for automatically generating event relevant marketing devices 200 is entered, in whole, or in part, into merchant computing system 100 via an I/O device (not shown), such as from a CD, DVD, floppy disk, portable hard drive, memory stick, download site, or other medium and/or computer program product as defined herein.

In one embodiment, merchant computing system 100 is a mobile computing system such as, but not limited to: a mobile phone; a smart phone; an Internet appliance; any SMS capable system; or any other mobile computing system as discussed herein, and/or as known in the art at the time of filing, and/or as developed after the time of filing.

In one embodiment, merchant computing system 100 is any computing system discussed herein, and/or as known in the art at the time of filing, and/or as developed after the time of filing, such as, but not limited to, a mobile computing systems, a desktop computing system, a laptop computing system, a notebook computing system, a workstation, a two-way pager, a cellular telephone, a smart phone, a digital wireless telephone, a Personal Digital Assistant (PDA), a server computer, an Internet appliance, any other device, or any desired combination of these devices, that includes components that can execute all, or part, of process for automatically generating event relevant marketing devices 200 in accordance with at least one of the embodiments as described herein.

As also seen in FIG. 1, consumer computing system 150 typically includes a central processing unit (CPU) 151, an input/output (I/O) interface 155, and a memory system 153. In one embodiment, memory system 153 includes all, or part of, process for automatically generating event relevant marketing devices 200. In one embodiment, process for automatically generating event relevant marketing devices 200 is stored, in whole, or in part, in memory system 153.

In one embodiment, memory system 153 includes all, or part of, marketing device data 152 representing one or more event relevant marketing devices generated by process for automatically generating event relevant marketing devices 200 and sent to consumer computing system 150.

Consumer computing system 150 may further include standard consumer interface devices such as a keyboard (not shown), a mouse (not shown), a printer (not shown), and a display device (not shown), as well as, one or more standard input/output (I/O) devices (not shown), such as a compact disk (CD) or Digital Video Disc (DVD) drive, floppy disk drive, or other device capable of inputting data to, and outputting data from, consumer computing system 150, whether available or known at the time of filing or as later developed.

In one embodiment, process for automatically generating event relevant marketing devices 200 is entered, in whole, or in part, into consumer computing system 150 via an I/O device (not shown), such as from a CD, DVD, floppy disk, portable hard drive, memory stick, download site, or other medium and/or computer program product as defined herein.

In one embodiment, consumer computing system 150 is a mobile computing system such as, but not limited to: a mobile phone; a smart phone; an Internet appliance; any SMS capable system; or any other mobile computing system as discussed herein, and/or as known in the art at the time of filing, and/or as developed after the time of filing.

In one embodiment, consumer computing system 150 is any computing system discussed herein, and/or as known in the art at the time of filing, and/or as developed after the time of filing, such as, but not limited to, a mobile computing systems, a desktop computing system, a laptop computing system, a notebook computing system, a workstation, a two-way pager, a cellular telephone, a smart phone, a digital wireless telephone, a Personal Digital Assistant (PDA), a server computer, an Internet appliance, any other device, or any desired combination of these devices, that includes components that can execute all, or part, of process for automatically generating event relevant marketing devices 200 in accordance with at least one of the embodiments as described herein.

Also shown in FIG. 1 is consumer profile database 180. In one embodiment, consumer profile database 180 is a data storage device, a designated server system or computing system, or a designated portion of one or more server systems or computing systems, such as computing systems 100, 150 and 120, or a distributed database, or an external and/or portable hard drive. In one embodiment, consumer profile database 180 is a dedicated mass storage device implemented in software, hardware, or a combination of hardware and software. In one embodiment, consumer profile database 180 is a web-based function.

As discussed in more detail below, in one embodiment, consumer profile database 180 is under the control of a process for automatically generating event relevant marketing devices, such as exemplary process 200 and includes profile data associated with one or more consumers including, but not limited to any one or more of: general demographic data associated with the consumer such as region of residence and/or employment, sex, religious beliefs/affiliations, etc.; the consumer's hobbies and/or interests, such as sports played/followed, entertainment preferences, etc.; the consumer's age; the consumer's occupation; the consumer's marital status; the consumer's number of dependents; and/or any other consumer profile data the consumer cares to provide and/or desired.

Also shown in FIG. 1 is events data database 170. In one embodiment, events data database 170 is a data storage device, a designated server system or computing system, or a designated portion of one or more server systems or computing systems, such as computing systems 100, 150 and 120, or a distributed database, or an external and/or portable hard drive. In one embodiment, events data database 170 is a dedicated mass storage device implemented in software, hardware, or a combination of hardware and software. In one embodiment, events data database 170 is a web-based function. As discussed in more detail below, in one embodiment, events data database 170 is under the control of a process for automatically generating event relevant marketing devices, such as exemplary process 200.

In one embodiment, events data database 170 includes events data 172 such as, but not limited to data representing: religious holidays; religious festivals; secular holidays; secular festivals; regional holidays; regional festivals; sporting matches; races; entertainment-based engagements, such concerts; or any other events that are likely to attract consumer's and/or consumer's attention, associated with one or more areas, and/or regions, of interest to a merchant.

In one embodiment, at least part of events data 172 is obtained by events data database 170 from one or more events data sources 132 and network 130. In one embodiment, events data sources 132 include, but are not limited to: local, regional, and/or national calendars; religious calendars; local and regional newspapers and other printed media; local, regional and/or government sources; sporting organizations and/or sporting organization calendars; one or more sports teams and/or team calendars; local, regional, and/or national radio and/or TV stations; local, regional, and/or national web-sites; the Internet; blogs and/or social media sites; subscription services; subscribers; and/or any other source of events, events calendars, and event dates, as discussed herein, and/or as known in the art at the time of filing, and/or as developed after the time of filing.

In one embodiment, computing systems 100 and 150 are linked to marketing device server system 120 via communications channels 140A and 140B, respectively. In various embodiments, either communications channel 140A or communications channel 140B, or both communications channels 140A and 140B can be, but are not limited to: a mobile communication link, such as a mobile phone link; a land-line phone link; a cable-based communications link; a satellite communications link; the Internet, or other network communications link; and/or any other communications link, or combination of communications links, as discussed herein, and/or as known in the art at the time of filing, and/or as developed after the time of filing.

In various embodiments, either communications channel 140A or communications channel 140B, or both communications channels 140A and 140B, are any SMS communication link as discussed herein, and/or as known in the art at the time of filing, and/or as developed after the time of filing. As noted above, Short Message Service (SMS) is the text communication service component of phone, web, or mobile communication systems. As also noted above, SMS uses relatively ridged standardized communications protocols that allow the exchange of only very short text messages between fixed line or mobile phone devices.

As seen in FIG. 1, in one embodiment, consumer profile database 180 and events data database 170 are coupled to marketing device server system 120 via network 130.

Network 130 can be any network or network system that is of interest to a consumer such as, a peer-to-peer network, a hybrid peer-to-peer network, a Local Area Network (LAN), a Wide Area Network (WAN), a public network, such as the Internet, a private network, a combination of different network types, or other wireless, wired, and/or a wireless and wired combination network capable of allowing communication between two or more computing systems, whether available or known at the time of filing or as later developed.

In one embodiment, marketing device server system 120 includes a server system display device 125, a server system processor 121, an I/O interface 122 and a memory 123.

As seen in FIG. 1, in one embodiment, memory 123 includes all, or part of, process for automatically generating event relevant marketing devices 200.

As seen in FIG. 1, in one embodiment, memory 123, and/or process for automatically generating event relevant marketing devices 200 include: offer data 102 from merchant computing system 100; events data 172 from events data sources 132 and/or events data database 170; and consumer profile data 182 from consumer profile database 180.

As seen in FIG. 1, in one embodiment, memory 123, and/or process for automatically generating event relevant marketing devices 200 includes marketing device matching engine 124 and marketing device data 152.

In one embodiment, marketing device matching engine 124 is used, under the direction of one or more processors, such as processor 121, to match at least part of offer data 102 and a portion of the events data 172 representing an identified relevant event and, in one embodiment, part of consumer profile data 182.

In one embodiment, marketing device matching engine 124 is also used to automatically generate marketing device data 152 representing at least one event relevant marketing device that includes at least part of the matched offer data 102 and at least part of the matched relevant event data 172.

In one embodiment, marketing device server system 120 is used as a distribution means for distributing one or more marketing devices represented by marketing device data 152 to one or more consumers, and/or consumer computing systems 150.

In one embodiment, marketing device server system 120 is used in a station-to-station arrangement, such as a peer-to-peer, or hybrid peer-to peer, arrangement, as an indexing and/or central server used to connect a first computing system, such as merchant computing system 100, and a second computing system, such as consumer computing system 150.

In one embodiment, marketing device server system 120 is used, controlled, and/or accessible by, a provider of and/or a system and process for automatically generating event relevant marketing devices, such as process for automatically generating event relevant marketing devices 200. In one embodiment, marketing device server system 120 is any computing system discussed herein, and/or as known in the art at the time of filing, and/or as developed after the time of filing, such as, but not limited to, a mobile computing system, a desktop computing system, a laptop computing system, a notebook computing system, a workstation, a two-way pager, a cellular telephone, a smart phone, a digital wireless telephone, a Personal Digital Assistant (PDA), a server computer, an Internet appliance, any other device, or any desired combination of these devices, that includes components that can execute all, or part, of a process for automatically generating event relevant marketing devices, and/or a computing system implemented financial management system, in accordance with at least one of the embodiments as described herein.

In one embodiment, computing systems 100 and 150, consumer profile database 180, events data database 170, marketing device server system 120, and network 130 are part of a cloud computing environment.

Those of skill in the art will readily recognize that the components shown in FIG. 1, such as computing systems 100 and 150, consumer profile database 180, events data database 170, marketing device server system 120, and their respective components, are shown for illustrative purposes only and that architectures with more or fewer components can implement, and benefit from, the invention. Moreover, one or more components of merchant computing system 100, consumer computing system 150, consumer profile database 180, events data database 170, and marketing device server system 120 may be located remotely from their respective system and accessed via network, as discussed herein. In addition, the particular type of, and configuration of, computing systems 100 and 150, consumer profile database 180, events data database 170, and marketing device server system 120 are not relevant.

Although a process for automatically generating event relevant marketing devices, such as process for automatically generating event relevant marketing devices 200, is sometimes referred to herein, alternatively, as a process, an application, a module, a program, a component of a software system, a component of a software package, a component of a parent system, a plug-in, or a feature of a parent system, this terminology is illustrative only. In some embodiments, a process for automatically generating event relevant marketing devices, such as process for automatically generating event relevant marketing devices 200, is capable of being called from an application or the operating system. In one embodiment, an application, process, or program is generally defined to be any executable code. Moreover, those of skill in the art will understand that when it is said that an application, process, or an operation takes some action, the action is the result of executing one or more instructions by a processor, such as processor 121. In one embodiment, execution of a process by processor 121, results in the operations of an agent computer process (not shown) and/or a rule computer process (not shown).

In one embodiment, a process for automatically generating event relevant marketing devices, such as process for automatically generating event relevant marketing devices 200, is a computer application or process implemented and/or run and/or stored, in full, or in part, in, or on, a computer program product. Herein, a computer program product comprises a medium and/or I/O device configured to store or transport computer readable code, whether available or known at the time of filing or as later developed. Some examples of computer program products are CDs, DVDs, ROM cards, floppy discs, magnetic tapes, computer hard drives, portable hard drives, flash memory, volatile and non-volatile memory sticks, servers on a network, such as marketing device server system 120 of FIG. 1, and signals transmitted over a network, such as network 130 of FIG. 1, or other media or process capable of delivering computer readable data representing computer readable code, whether available or known at the time of filing or as later developed. This medium may belong to a computing system, such as computing systems 100 and 150 of FIG. 1, described above. However, in some embodiments, the medium also may be removable and/or remote from the computing system.

### Process

Herein, the terms “user”, “merchant” and “user merchant” are used interchangeably to denote any party that wishes to have event relevant marketing devices generated using a process for automatically generating event relevant marketing devices, and/or an authorized agent of any party that wishes to have event relevant marketing devices generated using a process for automatically generating event relevant marketing devices, and/or any other authorized party associated with any party that wishes to have event relevant marketing devices generated using a process for automatically generating event relevant marketing devices.

As used herein, the terms “consumer” and “customer” are used interchangeably and include, but are not limited to, any party that receives event relevant marketing devices generated using a process for automatically generating event relevant marketing devices, and/or an authorized agent of any party that receives event relevant marketing devices generated using a process for automatically generating event relevant marketing devices, and/or any other authorized party associated with any party that receives event relevant marketing devices generated using a process for automatically generating event relevant marketing devices.

As used herein, the term “computing system”, includes, but is not limited to: a mobile computing system; a desktop computer; a portable computer; a workstation; a two-way pager; a cellular telephone; a smart phone; a digital wireless telephone; a Personal Digital Assistant (PDA); a media player, i.e., an MP3 player and/or other music and/or video player; a server computer; an Internet appliance; or any other device that includes components that can execute all, or part, of any one of the processes and/or operations as described herein. In addition, as used herein, the term computing system, can denote, but is not limited to, computing systems made up of multiple: computers; wireless devices; cellular telephones; digital telephones; two-way pagers; PDAs; media players; server computers; or any desired combination of these devices, that are coupled to perform the processes and/or operations as described herein.

As used herein, the term “network” includes any network or network system such as, but not limited to, a peer-to-peer network, a hybrid peer-to-peer network, a Local Area Network (LAN), a Wide Area Network (WAN), a public network, such as the Internet, a private network, a cellular network, a combination of different network types, or other wireless, wired, and/or a wireless and wired combination network capable of allowing communication between two or more computing systems, whether available or known at the time of filing or as later developed.

As used herein, the term “database” includes any data storage mechanism known at the time of filing or as developed thereafter, such as, but not limited to: a data storage device; a designated server system or computing system, or a designated portion of one or more server systems or computing systems; a mobile computing system; a server system network; a distributed database; or an external and/or portable hard drive. Herein, the term “database” can refer to a dedicated mass storage device implemented in software, hardware, or a combination of hardware and software. Herein, the term “database” can refer to a web-based function. Herein, the term “database” can refer to data storage means that is part of, or under the control of, any computing system, as defined herein, known at the time of filing, or as developed thereafter.

In accordance with one embodiment, a process for automatically generating event relevant marketing devices begins, in one embodiment, when a merchant/product/service type-to-event type mapping system is created that, in one embodiment, uses keywords, or other data, to map, and/or match, merchants, and/or services offered by merchants, and/or products offered by merchants, to types of events that are potentially related to, and/or are associated with, and/or logically connected to, the merchants, services, and/or products. In one embodiment, events data is obtained from one or more sources that indicates upcoming events such as, but not limited to, holidays, festivals, sporting matches, races, and/or entertainment-based engagements, associated with one or more areas, and/or regions, of interest to a merchant. In one embodiment, offer data to be associated with a marketing device, such as the business location, products and/or services subject to the offer, discounts and/or prices offered, any other relevant terms of the offer, and/or any possible events the merchant desires to connect with the offer, is obtained from the merchant. In one embodiment, the offer data, and/or the merchant submitting the offer data, indicates the merchant, and/or services offered by merchant, and/or products offered by merchant. In one embodiment, the offer data is mapped to one or more event types using the merchant/product/service type-to-event type mapping system. In one embodiment, the events data is searched to identify a relevant event represented by the events data that is of the event type mapped to the offer data. In one embodiment, the offer data and the portion of the events data representing the identified relevant event are “matched”. In one embodiment, the matched offer data and relevant event data is automatically transformed into one or more event relevant marketing devices that include at least part of the matched offer data and at least part of the matched relevant event data. In one embodiment, the one or more event relevant marketing devices are presented to the user/merchant for selection, review, and/or approval. In one embodiment, the selected/approved one or more event relevant marketing devices are then distributed to one or more consumers, in one embodiment, at a time calculated to correlate with the matched relevant event.

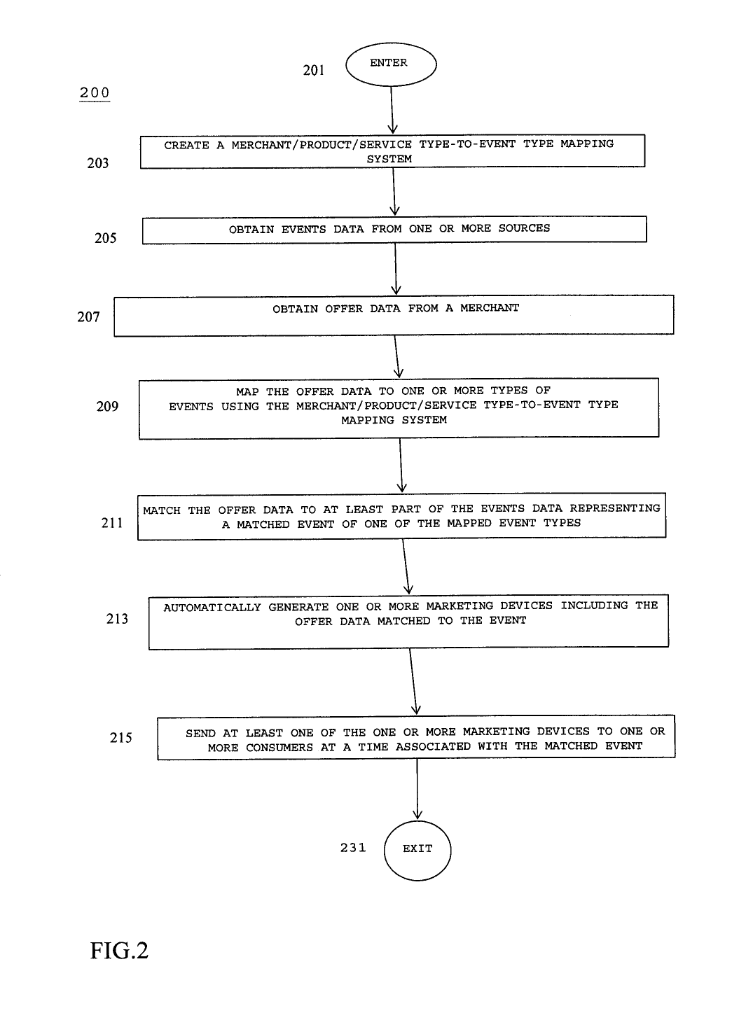

FIG. 2 a flow chart depicting a process for automatically generating event relevant marketing devices 200 in accordance with one embodiment. Process for automatically generating event relevant marketing devices 200 begins at ENTER OPERATION 201 of FIG. 2 and process flow proceeds to CREATE A MERCHANT/PRODUCT/SERVICE TYPE-TO-EVENT TYPE MAPPING SYSTEM OPERATION 203.

In one embodiment, at CREATE A MERCHANT/PRODUCT/SERVICE TYPE-TO-EVENT TYPE MAPPING SYSTEM OPERATION 203 a merchant/product/service type-to-event type mapping system is created that, in one embodiment, uses keywords, or other data, to map, and/or match, merchants, and/or services offered by merchants, and/or products offered by merchants, to types of events that are potentially related to, and/or are associated with, and/or logically connected to, the merchants, services, and/or products.

In one embodiment, the merchant/product/service type-to-event type mapping system of CREATE A MERCHANT/PRODUCT/SERVICE TYPE-TO-EVENT TYPE MAPPING SYSTEM OPERATION 203 is a mapping table, look-up-table, or other mapping system, created to link a given business type, product type, or service type to one or more appropriate, or logically related, event types.

As a specific example, a merchant or business type known to be associated with selling jewelry, or including the keyword “jewelry” in the description of its products, might be mapped, or linked, to the events “Valentine's Day”, and/or “Christmas”, and/or “graduation”, or the keywords “wife”, and/or “engagement” and/or “graduation” using one embodiment of the merchant/product/service type-to-event type mapping system of CREATE A MERCHANT/PRODUCT/SERVICE TYPE-TO-EVENT TYPE MAPPING SYSTEM OPERATION 203. However, a merchant or business type known to be associated with selling jewelry, or including the keyword “jewelry” in the description of its products, would not likely be mapped, or linked to, event types involving sports, or key words associated with various sporting events.

On the other hand, a merchant or business type known to be associated with selling food, and/or alcohol, or including the keyword “pizza” or “beer” in the description of its products, might well be mapped, or linked, to event types involving sports, or key words associated with various sporting events using one embodiment of the merchant/product/service type-to-event type mapping system CREATE A MERCHANT/PRODUCT/SERVICE TYPE-TO-EVENT TYPE MAPPING SYSTEM OPERATION 203.

The actual mapping performed by the merchant/product/service type-to-event type mapping system of CREATE A MERCHANT/PRODUCT/SERVICE TYPE-TO-EVENT TYPE MAPPING SYSTEM OPERATION 203, and/or the keywords, or other data used, to map, and/or match, merchants, and/or services offered by merchants, and/or products offered by merchants, to types of events that are potentially related to, and/or are associated with, and/or logically connected to, the merchants, services, and/or products, will vary significantly from region-to-region. In addition, procedures for creating and implementing mapping functions, and matching engines, in general are known. Consequently, a more specific discussion of specific implementations of the merchant/product/service type-to-event type mapping system of CREATE A MERCHANT/PRODUCT/SERVICE TYPE-TO-EVENT TYPE MAPPING SYSTEM OPERATION 203 is omitted here to avoid detracting from the invention.

In one embodiment, once a merchant/product/service type-to-event type mapping system is created that, in one embodiment, uses keywords, or other data, to map, and/or match, merchants, and/or services offered by merchants, and/or products offered by merchants, to types of events that are potentially related to, and/or are associated with, and/or logically connected to, the merchants, services, and/or products at CREATE A MERCHANT/PRODUCT/SERVICE TYPE-TO-EVENT TYPE MAPPING SYSTEM OPERATION 203 process flow proceeds to OBTAIN EVENTS DATA FROM ONE OR MORE SOURCES OPERATION 205.

In one embodiment, at OBTAIN EVENTS DATA FROM ONE OR MORE SOURCES OPERATION 205 events data is obtained from one or more sources that indicates upcoming events such as, but not limited to, holidays, festivals, sporting matches, races, and/or entertainment-based engagements, associated with one or more areas, and/or regions, of interest to a merchant.

In one embodiment, at OBTAIN EVENTS DATA FROM ONE OR MORE SOURCES OPERATION 205 the events data is obtained from one or more sources.

In one embodiment, at OBTAIN EVENTS DATA FROM ONE OR MORE SOURCES OPERATION 205 the events data is obtained from any one or more of, but not limited to, the following sources: local, regional, and/or national calendars; religious calendars; local and regional newspapers and other printed media; local, regional and/or government sources; sporting organizations and/or sporting organization calendars; one or more sports teams and/or team calendars; local, regional, and/or national radio and/or TV stations; local, regional, and/or national web-sites; the Internet; blogs and/or social media sites; subscription services; subscribers; and/or any other source of events, events calendars, and event dates, as discussed herein, and/or as known in the art at the time of filing, and/or as developed after the time of filing.

In various embodiments, the events data of OBTAIN EVENTS DATA FROM ONE OR MORE SOURCES OPERATION 205 indicates various events, and/or event dates and times, such as, but not limited to: religious holidays; religious festivals; secular holidays; secular festivals; regional holidays; regional festivals; sporting matches; races; entertainment-based engagements, such concerts; or any other events that are likely to attract consumers and/or consumers' attention, associated with one or more areas, and/or regions, of interest to a merchant.

In various embodiments, the events data of OBTAIN EVENTS DATA FROM ONE OR MORE SOURCES OPERATION 205 is stored.

In various embodiments, the events data of OBTAIN EVENTS DATA FROM ONE OR MORE SOURCES OPERATION 205 is stored in a memory system, or database, or in a cache memory, or in any main memory or mass memory, associated with any computing system as discussed herein, and/or as known in the art at the time of filing, and/or as developed after the time of filing.

In various embodiments, the events data of OBTAIN EVENTS DATA FROM ONE OR MORE SOURCES OPERATION 205 in whole, or in part, is stored in any computing system, such as marketing device server 120 of FIG. 1, and/or a database, such as database 170 of FIG. 1, or any other device, in another location, or on/in a computer readable medium, and/or any other computer program product.

Returning to FIG. 2, in various embodiments, the events data of OBTAIN EVENTS DATA FROM ONE OR MORE SOURCES OPERATION 205, in whole, or in part, is stored on a webpage, in a web-based system, or on a public network such as the Internet.

In one embodiment, once events data is obtained from one or more sources that indicates upcoming events such as, but not limited to, holidays, festivals, sporting matches, races, and/or entertainment-based engagements, associated with one or more areas, and/or regions, of interest to a merchant at OBTAIN EVENTS DATA FROM ONE OR MORE SOURCES OPERATION 205 process flow proceeds to OBTAIN OFFER DATA FROM A MERCHANT OPERATION 207.

In one embodiment, at OBTAIN OFFER DATA FROM A MERCHANT OPERATION 207 offer data to be associated with a marketing device, such as the business location, products and/or services subject to the offer, discounts and/or prices offered, any other relevant terms of the offer, and/or any possible events the merchant desires to connect with the offer, is obtained from the merchant.

In one embodiment, at OBTAIN OFFER DATA FROM A MERCHANT OPERATION 207 the offer data is obtained from a merchant via a computing system, such as merchant computing system 100 of FIG. 1.

Returning to FIG. 2, in one embodiment, the offer data is obtained at OBTAIN OFFER DATA FROM A MERCHANT OPERATION 207 from a merchant via a mobile computing system, such as a mobile phone.

In one embodiment, the offer data is obtained at OBTAIN OFFER DATA FROM A MERCHANT OPERATION 207 from a merchant via a Short Message Service (SMS) message sent via an SMS capable communications network and an SMS capable system.

In one embodiment, the offer data is obtained at OBTAIN OFFER DATA FROM A MERCHANT OPERATION 207 from a merchant via a user interface display and designated text fields and/or in a designated text format.

In one embodiment, the offer data is obtained at OBTAIN OFFER DATA FROM A MERCHANT OPERATION 207 using any means, method, process, and/or procedure, and/or any combination of means, methods, processes, and/or procedures, of obtaining data, as discussed herein, and/or as known in the art at the time of filing, and/or as developed after the time of filing.

In one embodiment, the offer data of OBTAIN OFFER DATA FROM A MERCHANT OPERATION 207 includes, but is not limited to, any one or more of: the name of the merchant and/or the merchant's business; the products sold by the merchant and/or the merchant's business; the services provided by the merchant and/or the merchant's business; the products and/or services that are the subject of the offer data; the terms of the offer, such as discount, price, bundled products, etc.; any conditions of the offer, i.e., expiration dates, restrictions on use, bundled products, etc.; any events or events types the merchant feels are good candidates to link with the offer data; and/or any other offer data the merchant desires to provide and/or is required by the provider of process for automatically generating event relevant marketing devices 200.

In one embodiment, the offer data of OBTAIN OFFER DATA FROM A MERCHANT OPERATION 207, and/or the merchant submitting the offer data, must indicate, at a minimum, the merchant/business, and/or at least some of the services and/or products offered by the merchant/business.

In one embodiment, the offer data of OBTAIN OFFER DATA FROM A MERCHANT OPERATION 207 is stored.

In various embodiments, the offer data of OBTAIN OFFER DATA FROM A MERCHANT OPERATION 207 is stored in a memory system, or database, or in a cache memory, or in any main memory or mass memory, associated with any computing system as discussed herein, and/or as known in the art at the time of filing, and/or as developed after the time of filing.

In various embodiments, the offer data of OBTAIN OFFER DATA FROM A MERCHANT OPERATION 207 in whole, or in part, is stored in any computing system, such as marketing device server 120 of FIG. 1, and/or a database, such as database 170 of FIG. 1, or any other device, in another location, or on/in a computer readable medium, and/or any other computer program product.

Returning to FIG. 2, in various embodiments, the offer data of OBTAIN OFFER DATA FROM A MERCHANT OPERATION 207, in whole, or in part, is stored on a webpage, in a web-based system, or on a public network such as the Internet.

In one embodiment, once offer data to be associated with a marketing device, such as the business location, products and/or services subject to the offer, discounts and/or prices offered, any other relevant terms of the offer, and/or any possible events the merchant desires to connect with the offer, is obtained from the merchant at OBTAIN OFFER DATA FROM A MERCHANT OPERATION 207 process flow proceeds to MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209.

In one embodiment, at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209 the offer data of OBTAIN OFFER DATA FROM A MERCHANT OPERATION 207 is mapped to one or more event types using the merchant/product/service type-to-event type mapping system of CREATE A MERCHANT/PRODUCT/SERVICE TYPE-TO-EVENT TYPE MAPPING SYSTEM OPERATION 203.

In one embodiment, at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209 at least part of the offer data is mapped to one or more event types using the merchant/product/service type-to-event type mapping system as discussed above.

In one embodiment, at least part of the offer data is mapped to one or more event types using the merchant/product/service type-to-event type mapping system under the direction of one or more processors, such as processor 121, of FIG. 1, associated with one or more computing systems, such as marketing device server system 120, of FIG. 1.

Returning to FIG. 2, in one embodiment, once the offer data of OBTAIN OFFER DATA FROM A MERCHANT OPERATION 207 is mapped to one or more event types using the merchant/product/service type-to-event type mapping system of CREATE A MERCHANT/PRODUCT/SERVICE TYPE-TO-EVENT TYPE MAPPING SYSTEM OPERATION 203 at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209 process flow proceeds to MATCH THE OFFER DATA TO AT LEAST PART OF THE EVENTS DATA REPRESENTING A MATCHED EVENT OF ONE OF THE MAPPED EVENT TYPES OPERATION 211.

In one embodiment, at MATCH THE OFFER DATA TO AT LEAST PART OF THE EVENTS DATA REPRESENTING A MATCHED EVENT OF ONE OF THE MAPPED EVENT TYPES OPERATION 211 the events data of OBTAIN EVENTS DATA FROM ONE OR MORE SOURCES OPERATION 205 is searched to identify a relevant event represented by the events data that is of the event type mapped to the offer data at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209 and the offer data and the portion of the events data representing the identified relevant event are “matched”.

In one embodiment, at MATCH THE OFFER DATA TO AT LEAST PART OF THE EVENTS DATA REPRESENTING A MATCHED EVENT OF ONE OF THE MAPPED EVENT TYPES OPERATION 211 the events data is searched to identify at least one relevant event represented by the events data that is of the event type mapped to the offer data using one or more processors, such as processor 121, of FIG. 1, associated with one or more computing systems, such as marketing device server system 120, of FIG. 1.

Returning to FIG. 2, in one embodiment, at MATCH THE OFFER DATA TO AT LEAST PART OF THE EVENTS DATA REPRESENTING A MATCHED EVENT OF ONE OF THE MAPPED EVENT TYPES OPERATION 211 the offer data and the portion of the events data representing the identified relevant event are “matched”, and/or linked using one or more processors, such as processor 121, of FIG. 1, associated with one or more computing systems, such as marketing device server system 120, of FIG. 1.

Returning to FIG. 2, in one embodiment, once the events data of OBTAIN EVENTS DATA FROM ONE OR MORE SOURCES OPERATION 205 is searched to identify a relevant event represented by the events data that is of the event type mapped to the offer data at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209 and the offer data and the portion of the events data representing the identified relevant event are “matched” at MATCH THE OFFER DATA TO AT LEAST PART OF THE EVENTS DATA REPRESENTING A MATCHED EVENT OF ONE OF THE MAPPED EVENT TYPES OPERATION 211, process flow proceeds to AUTOMATICALLY GENERATE ONE OR MORE MARKETING DEVICES INCLUDING THE OFFER DATA MATCHED TO THE EVENT OPERATION 213.

In one embodiment, at AUTOMATICALLY GENERATE ONE OR MORE MARKETING DEVICES INCLUDING THE OFFER DATA MATCHED TO THE EVENT OPERATION 213 the matched offer data and relevant event data of MATCH THE OFFER DATA TO AT LEAST PART OF THE EVENTS DATA REPRESENTING A MATCHED EVENT OF ONE OF THE MAPPED EVENT TYPES OPERATION 211 is automatically transformed into one or more event relevant marketing devices that include at least part of the matched offer data and at least part of the matched relevant event data of MATCH THE OFFER DATA TO AT LEAST PART OF THE EVENTS DATA REPRESENTING A MATCHED EVENT OF ONE OF THE MAPPED EVENT TYPES OPERATION 211.

In one embodiment, at AUTOMATICALLY GENERATE ONE OR MORE MARKETING DEVICES INCLUDING THE OFFER DATA MATCHED TO THE EVENT OPERATION 213, the matched offer data and relevant event data is used to automatically generate at least one event relevant marketing device that includes at least part of the matched offer data and at least part of the matched relevant event data using one or more processors, such as processor 121, of FIG. 1, associated with one or more computing systems, such as marketing device server system 120, of FIG. 1.

Returning to FIG. 2, in one embodiment, at AUTOMATICALLY GENERATE ONE OR MORE MARKETING DEVICES INCLUDING THE OFFER DATA MATCHED TO THE EVENT OPERATION 213 at least one event relevant marketing device that includes at least part of the matched offer data and at least part of the matched relevant event data is presented to the user merchant for review and/or approval and/or editing.

In one embodiment, at AUTOMATICALLY GENERATE ONE OR MORE MARKETING DEVICES INCLUDING THE OFFER DATA MATCHED TO THE EVENT OPERATION 213 at least one event relevant marketing device that includes at least part of the matched offer data and at least part of the matched relevant event data is presented to the user merchant for review and/or approval and/or editing on a merchant computing system, such as merchant computing system 100 of FIG. 1.

Returning to FIG. 2, in one embodiment, at AUTOMATICALLY GENERATE ONE OR MORE MARKETING DEVICES INCLUDING THE OFFER DATA MATCHED TO THE EVENT OPERATION 213 the matched offer data and relevant event data is used to automatically generate at least two event relevant marketing devices that include at least part of the matched offer data and at least part of the matched relevant event data and the two or more event relevant marketing devices are presented to the user/merchant for selection of one of the marketing offers and/or review and/or approval and/or editing.

In one embodiment, at AUTOMATICALLY GENERATE ONE OR MORE MARKETING DEVICES INCLUDING THE OFFER DATA MATCHED TO THE EVENT OPERATION 213 the matched offer data and relevant event data is used to automatically generate at least two event relevant marketing devices that include at least part of the matched offer data and at least part of the matched relevant event data and the two or more event relevant marketing devices are presented to the user/merchant for selection of one of the marketing offers and/or review and/or approval and/or editing on a merchant computing system, such as merchant computing system 100 of FIG. 1.

Returning to FIG. 2, in one embodiment, once the matched offer data and relevant event data of MATCH THE OFFER DATA TO AT LEAST PART OF THE EVENTS DATA REPRESENTING A MATCHED EVENT OF ONE OF THE MAPPED EVENT TYPES OPERATION 211 is automatically transformed into one or more event relevant marketing devices that include at least part of the matched offer data and at least part of the matched relevant event data at AUTOMATICALLY GENERATE ONE OR MORE MARKETING DEVICES INCLUDING THE OFFER DATA MATCHED TO THE EVENT OPERATION 213 process flow proceeds to SEND AT LEAST ONE OF THE ONE OR MORE MARKETING DEVICES TO ONE OR MORE CONSUMERS AT A TIME ASSOCIATED WITH THE MATCHED EVENT OPERATION 215.

In one embodiment, at SEND AT LEAST ONE OF THE ONE OR MORE MARKETING DEVICES TO ONE OR MORE CONSUMERS AT A TIME ASSOCIATED WITH THE MATCHED EVENT OPERATION 215 the selected/approved one or more event relevant marketing devices of AUTOMATICALLY GENERATE ONE OR MORE MARKETING DEVICES INCLUDING THE OFFER DATA MATCHED TO THE EVENT OPERATION 213 are distributed to one or more consumers, in one embodiment, at a time calculated to correlate with the matched relevant event of MATCH THE OFFER DATA TO AT LEAST PART OF THE EVENTS DATA REPRESENTING A MATCHED EVENT OF ONE OF THE MAPPED EVENT TYPES OPERATION 211.

In one embodiment, at SEND AT LEAST ONE OF THE ONE OR MORE MARKETING DEVICES TO ONE OR MORE CONSUMERS AT A TIME ASSOCIATED WITH THE MATCHED EVENT OPERATION 215 the selected/approved one or more event relevant marketing devices are distributed to one or more consumers at one or more computing systems associated with the one or more consumers.

In one embodiment, at SEND AT LEAST ONE OF THE ONE OR MORE MARKETING DEVICES TO ONE OR MORE CONSUMERS AT A TIME ASSOCIATED WITH THE MATCHED EVENT OPERATION 215 the selected/approved one or more event relevant marketing devices are distributed to one or more consumers via one or more computing systems associated with the one or more consumers, such as consumer computing system 150 of FIG. 1.

Returning to FIG. 2, in one embodiment, at SEND AT LEAST ONE OF THE ONE OR MORE MARKETING DEVICES TO ONE OR MORE CONSUMERS AT A TIME ASSOCIATED WITH THE MATCHED EVENT OPERATION 215 the selected/approved one or more event relevant marketing devices are distributed to one or more consumers via one or more mobile computing systems, such as mobile phones, associated with the one or more consumers.

In one embodiment, at SEND AT LEAST ONE OF THE ONE OR MORE MARKETING DEVICES TO ONE OR MORE CONSUMERS AT A TIME ASSOCIATED WITH THE MATCHED EVENT OPERATION 215 the selected/approved one or more event relevant marketing devices are distributed to one or more consumers via one or more Short Message Service (SMS) messages sent via one or more SMS capable communications networks and one or more SMS capable systems associated with the one or more consumers.

In one embodiment, once the selected/approved one or more event relevant marketing devices of AUTOMATICALLY GENERATE ONE OR MORE MARKETING DEVICES INCLUDING THE OFFER DATA MATCHED TO THE EVENT OPERATION 213 are distributed to one or more consumers, in one embodiment, at a time calculated to correlate with the matched relevant event of MATCH THE OFFER DATA TO AT LEAST PART OF THE EVENTS DATA REPRESENTING A MATCHED EVENT OF ONE OF THE MAPPED EVENT TYPES OPERATION 211 at SEND AT LEAST ONE OF THE ONE OR MORE MARKETING DEVICES TO ONE OR MORE CONSUMERS AT A TIME ASSOCIATED WITH THE MATCHED EVENT OPERATION 215 process flow proceeds to EXIT OPERATION 231.

In one embodiment at EXIT OPERATION 231 process for automatically generating event relevant marketing devices 200 is exited to await new data.

Using process for automatically generating event relevant marketing devices 200, in response to a user merchant providing only a minimal amount of data, i.e., the offer data, one or more event relevant marketing devices are automatically generated, and sent to consumers, on behalf of the user merchant.

This is possible because, in one embodiment: the determination of what events are coming up in one or more areas/regions associated with the merchant's business; the determination of which of the upcoming events are logically related, or relevant, to the merchant's products and/or services and/or the offer of the marketing device; the creation of the actual marketing device wording and ensuring the marketing device wording meets any formatting requirements for one or more distribution mechanisms, such as SMS character limits and formatting, in one or more languages; the translation of the marketing device, if necessary, into one or more languages associated with the areas where the determined relevant events are taking place; the tracking of the dates and/or times of the determined relevant events; and the determination of the best time to distribute the marketing devices to correlate the marketing devices to the dates and/or times of the determined relevant events, is performed automatically by process for automatically generating event relevant marketing devices 200 in the background and then the generated marketing devices are automatically distributed one or more consumers in a timely manner.

Therefore, using process for automatically generating event relevant marketing devices 200, more merchants, and particularly more small business owners/operators, will be able to distribute event relevant marketing devices thereby providing both merchants and consumers the opportunity to use highly relevant marketing devices at times when they will be of most use to the consumer.

In one embodiment, the one or more consumers to whom the selected/approved one or more event relevant marketing devices are distributed are themselves selected by matching consumer profile data associated with the one or more consumers to the relevant event data and/or offer data.

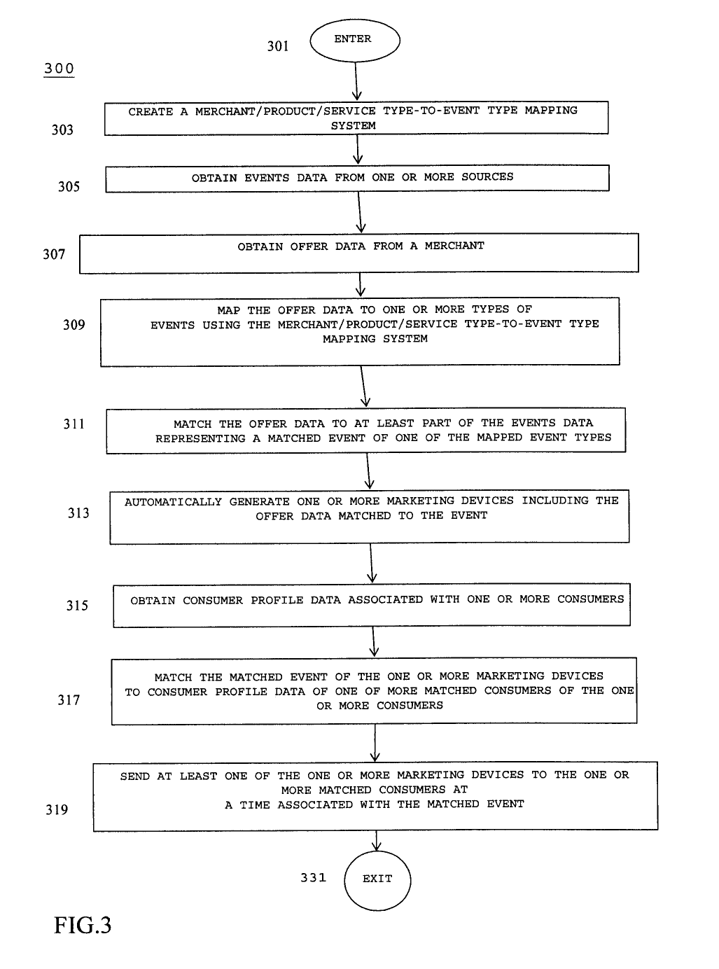

FIG. 3 a flow chart depicting a process for automatically generating event relevant marketing devices 300 in accordance with one embodiment. Process for automatically generating event relevant marketing devices 300 begins at ENTER OPERATION 301 of FIG. 3 and process flow proceeds to CREATE A MERCHANT/PRODUCT/SERVICE TYPE-TO-EVENT TYPE MAPPING SYSTEM OPERATION 303.

In one embodiment, the operations: CREATE A MERCHANT/PRODUCT/SERVICE TYPE-TO-EVENT TYPE MAPPING SYSTEM OPERATION 303; OBTAIN EVENTS DATA FROM ONE OR MORE SOURCES OPERATION 305; OBTAIN OFFER DATA FROM A MERCHANT OPERATION 307; MAP THE OFFER DATA TO ONE OR MORE TYPES OF EVENTS USING THE MERCHANT/PRODUCT/SERVICE TYPE-TO-EVENT TYPE MAPPING SYSTEM OPERATION 309; MATCH THE OFFER DATA TO AT LEAST PART OF THE EVENTS DATA REPRESENTING A MATCHED EVENT OF ONE OF THE MAPPED EVENT TYPES OPERATION 311; and AUTOMATICALLY GENERATE ONE OR MORE MARKETING DEVICES INCLUDING THE OFFER DATA MATCHED TO THE EVENT OPERATION 313 of FIG. 3, are substantially identical to operations: CREATE A MERCHANT/PRODUCT/SERVICE TYPE-TO-EVENT TYPE MAPPING SYSTEM OPERATION 203; OBTAIN EVENTS DATA FROM ONE OR MORE SOURCES OPERATION 205; OBTAIN OFFER DATA FROM A MERCHANT OPERATION 207; MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209; MATCH THE OFFER DATA TO AT LEAST PART OF THE EVENTS DATA REPRESENTING A MATCHED EVENT OF ONE OF THE MAPPED EVENT TYPES OPERATION 211; and AUTOMATICALLY GENERATE ONE OR MORE MARKETING DEVICES INCLUDING THE OFFER DATA MATCHED TO THE EVENT OPERATION 213 of FIG. 2. Consequently, the discussion above with respect to operations: CREATE A MERCHANT/PRODUCT/SERVICE TYPE-TO-EVENT TYPE MAPPING SYSTEM OPERATION 203; OBTAIN EVENTS DATA FROM ONE OR MORE SOURCES OPERATION 205; OBTAIN OFFER DATA FROM A MERCHANT OPERATION 207; MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209; MATCH THE OFFER DATA TO AT LEAST PART OF THE EVENTS DATA REPRESENTING A MATCHED EVENT OF ONE OF THE MAPPED EVENT TYPES OPERATION 211; and AUTOMATICALLY GENERATE ONE OR MORE MARKETING DEVICES INCLUDING THE OFFER DATA MATCHED TO THE EVENT OPERATION 213 of FIG. 2 is equally relevant to, and is incorporated herein for, similarly labeled the operations: CREATE A MERCHANT/PRODUCT/SERVICE TYPE-TO-EVENT TYPE MAPPING SYSTEM OPERATION 303; OBTAIN EVENTS DATA FROM ONE OR MORE SOURCES OPERATION 305; OBTAIN OFFER DATA FROM A MERCHANT OPERATION 307; MAP THE OFFER DATA TO ONE OR MORE TYPES OF EVENTS USING THE MERCHANT/PRODUCT/SERVICE TYPE-TO-EVENT TYPE MAPPING SYSTEM OPERATION 309; MATCH THE OFFER DATA TO AT LEAST PART OF THE EVENTS DATA REPRESENTING A MATCHED EVENT OF ONE OF THE MAPPED EVENT TYPES OPERATION 311; and AUTOMATICALLY GENERATE ONE OR MORE MARKETING DEVICES INCLUDING THE OFFER DATA MATCHED TO THE EVENT OPERATION 313 of FIG. 3.

In on embodiment, once the matched offer data and relevant event data of MATCH THE OFFER DATA TO AT LEAST PART OF THE EVENTS DATA REPRESENTING A MATCHED EVENT OF ONE OF THE MAPPED EVENT TYPES OPERATION 311 is automatically transformed into one or more event relevant marketing devices that include at least part of the matched offer data and at least part of the matched relevant event data at AUTOMATICALLY GENERATE ONE OR MORE MARKETING DEVICES INCLUDING THE OFFER DATA MATCHED TO THE EVENT OPERATION 313 process flow proceeds to OBTAIN CONSUMER PROFILE DATA ASSOCIATED WITH ONE OR MORE CONSUMERS OPERATION 315.

In one embodiment at, OBTAIN CONSUMER PROFILE DATA ASSOCIATED WITH ONE OR MORE CONSUMERS OPERATION 315 consumer profile data is obtained for one or more consumers.

In one embodiment, at OBTAIN CONSUMER PROFILE DATA ASSOCIATED WITH ONE OR MORE CONSUMERS OPERATION 315 consumer profile data, such as consumer profile data 182 of FIG. 1, is obtained for one or more consumers.

Returning to FIG. 3, in one embodiment, the consumer profile data is obtained at OBTAIN CONSUMER PROFILE DATA ASSOCIATED WITH ONE OR MORE CONSUMERS OPERATION 315 from any one or more of, but not limited to: the consumers themselves; computing systems associated with the consumers; mobile computing systems associated with the consumers; data collected by monitoring a consumers historical usage of marketing devices, including event relevant marketing devices; and/or any other source of consumer profile data, or combination of sources of consumer profile data, as discussed herein, and/or as known in the art at the time of filing, and/or as developed after the time of filing.

In one embodiment, the consumer profile data of OBTAIN CONSUMER PROFILE DATA ASSOCIATED WITH ONE OR MORE CONSUMERS OPERATION 315 includes, but is not limited to any one or more of: general demographic data associated with the consumer such as region of residence and/or employment, sex, religious beliefs/affiliations, etc.; the consumer's hobbies and/or interests, such as sports played/followed, entertainment preferences, etc.; the consumer's age; the consumer's occupation; the consumer's marital status; the consumer's number of dependents; and/or any other consumer profile data the consumer cares to provide and/or as is desired.

In one embodiment, the consumer profile data of OBTAIN CONSUMER PROFILE DATA ASSOCIATED WITH ONE OR MORE CONSUMERS OPERATION 315 is stored.

In one embodiment, the consumer profile data of OBTAIN CONSUMER PROFILE DATA ASSOCIATED WITH ONE OR MORE CONSUMERS OPERATION 315 is stored in a memory system, or database, or in a cache memory, or in any main memory or mass memory, associated with any computing system as discussed herein, and/or as known in the art at the time of filing, and/or as developed after the time of filing.

In various embodiments, the consumer profile data of OBTAIN CONSUMER PROFILE DATA ASSOCIATED WITH ONE OR MORE CONSUMERS OPERATION 315 in whole, or in part, is stored in any computing system, such as marketing device server 120 of FIG. 1, and/or a database, such as database 180 of FIG. 1, or any other device, in another location, or on/in a computer readable medium, and/or any other computer program product.

Returning to FIG. 3, in various embodiments, the consumer profile data of OBTAIN CONSUMER PROFILE DATA ASSOCIATED WITH ONE OR MORE CONSUMERS OPERATION 315, in whole, or in part, is stored on a webpage, in a web-based system, or on a public network such as the Internet.

In one embodiment, once consumer profile data is obtained for one or more consumers at OBTAIN CONSUMER PROFILE DATA ASSOCIATED WITH ONE OR MORE CONSUMERS OPERATION 315 process flow proceeds to MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317.

In one embodiment, at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317 the consumers' profile data of OBTAIN CONSUMER PROFILE DATA ASSOCIATED WITH ONE OR MORE CONSUMERS OPERATION 315 is searched to find matches between one or more consumers' profile data and the matched offer data and/or matched relevant event data of MATCH THE OFFER DATA TO AT LEAST PART OF THE EVENTS DATA REPRESENTING A MATCHED EVENT OF ONE OF THE MAPPED EVENT TYPES OPERATION 311.

In one embodiment, at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317 the consumers' profile data is searched to find matches between one or more consumers' profile data and the matched offer data and/or matched relevant event data using one or more processors, such as processor 121, of FIG. 1, associated with one or more computing systems, such as marketing device server system 120, of FIG. 1.

Returning to FIG. 3, in one embodiment, at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317 one or more matched consumers whose profile data matches the matched offer data and/or matched relevant event data are identified.

In one embodiment, at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317 one or more matched consumers whose profile data matches the matched offer data and/or matched relevant event data are identified using one or more processors, such as processor 121, of FIG. 1, associated with one or more computing systems, such as marketing device server system 120, of FIG. 1.

Returning to FIG. 3, in one embodiment, once the consumers' profile data of OBTAIN CONSUMER PROFILE DATA ASSOCIATED WITH ONE OR MORE CONSUMERS OPERATION 315 is searched to find matches between one or more consumers' profile data and the matched offer data and/or matched relevant event data of MATCH THE OFFER DATA TO AT LEAST PART OF THE EVENTS DATA REPRESENTING A MATCHED EVENT OF ONE OF THE MAPPED EVENT TYPES OPERATION 311 at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317, process flow proceeds to SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319.

In one embodiment, at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319 the selected/approved one or more event relevant marketing devices of AUTOMATICALLY GENERATE ONE OR MORE MARKETING DEVICES INCLUDING THE OFFER DATA MATCHED TO THE EVENT OPERATION 313 are distributed to the matched one or more consumers of MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317, in one embodiment, at a time calculated to correlate with the matched relevant event of MATCH THE OFFER DATA TO AT LEAST PART OF THE EVENTS DATA REPRESENTING A MATCHED EVENT OF ONE OF THE MAPPED EVENT TYPES OPERATION 311.

In one embodiment, at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319 the selected/approved one or more event relevant marketing devices are distributed to the matched one or more consumers at one or more computing systems associated with the matched one or more consumers, such as consumer computing system 150 of FIG. 1.

Returning to FIG. 3, in one embodiment, at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319 the selected/approved one or more event relevant marketing devices are distributed to the matched one or more consumers via one or more mobile computing systems, such as mobile phones, associated with the one or more consumers.

In one embodiment, at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319 the selected/approved one or more event relevant marketing devices are distributed to the matched one or more consumers via one or more Short Message Service (SMS) messages sent via one or more SMS capable communications networks and one or more SMS capable systems associated with the one or more consumers.

As a specific illustrative example, in one embodiment, assume a merchant/product/service type-to-event type mapping system is created at CREATE A MERCHANT/PRODUCT/SERVICE TYPE-TO-EVENT TYPE MAPPING SYSTEM OPERATION 203/303 that maps a merchant whose products description includes the keyword “pizza” with sporting events having keywords such as “baseball”, “football”, “cricket”, and “basketball”.

In this specific illustrative example, assume events data is obtained at OBTAIN EVENTS DATA FROM ONE OR MORE SOURCES OPERATION 205/305 that indicates a major cricket match scheduled for Sunday, May 3 at 7 P.M.

In this specific illustrative example, assume a merchant sells pizza and submits the following offer data via SMS at OBTAIN OFFER DATA FROM A MERCHANT OPERATION 207/307:
Item: Large Vegie Pizza
Offer: 10%, free coke

In this specific illustrative example, the offer data keyword “pizza” would be mapped to the events including the keywords “baseball”, “football”, “cricket”, and “basketball” using the merchant/product/service type-to-event type mapping system at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209.

In this specific example, the events data is searched to identify a relevant event, a “cricket” event represented by the events data that is of the event type mapped to the offer data and, in this case the major cricket match scheduled for Sunday, May 3.

In this specific example, the offer data, i.e., the keyword “pizza”, and the portion of the events data representing the identified relevant event, i.e., the keyword “cricket” in the events data indicating the major “cricket” match scheduled for Sunday, May 3 is “matched” at MATCH THE OFFER DATA TO AT LEAST PART OF THE EVENTS DATA REPRESENTING A MATCHED EVENT OF ONE OF THE MAPPED EVENT TYPES OPERATION 211/311.

In this specific example, the matched offer data and relevant event data is automatically transformed into one or more event relevant marketing devices that include at least part of the matched offer data and at least part of the matched relevant event data at AUTOMATICALLY GENERATE ONE OR MORE MARKETING DEVICES INCLUDING THE OFFER DATA MATCHED TO THE EVENT OPERATION 213/313. In this specific example, the one or more event relevant marketing devices could include the following event relevant marketing devices:
1. Invite your friends for today's major cricket match between RCB and DC, order a Vegie Pizza @10% off and free coke. Call 989898989898
2. Order a Veggie Pizza 10% off with free coke; take a break from cooking watch RCB Vs. DC @ 7 P.M. tonight.

In this specific example, the merchant would choose one of the event relevant marketing devices above for distribution at AUTOMATICALLY GENERATE ONE OR MORE MARKETING DEVICES INCLUDING THE OFFER DATA MATCHED TO THE EVENT OPERATION 213/313.

In one embodiment, in this specific example, consumers' profile data of OBTAIN CONSUMER PROFILE DATA ASSOCIATED WITH ONE OR MORE CONSUMERS OPERATION 315 is searched to find matches between one or more consumers' profile data and the matched offer data and/or matched relevant event data. For instance, the consumers' profile data could be searched for keywords such as “pizza” or “cricket”, or both “pizza” or “cricket” at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317. In this specific example, assume two or more consumers are matched to the keywords “pizza” and “cricket”. Then these consumers are identified as matched consumers.

In one embodiment, the selected event relevant marketing device is then distributed to the identified matched consumers at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319.

In this specific example, the selected/approved event relevant marketing device is distributed to the matched consumers via a Short Message Service (SMS) message sent via one or more SMS capable communications networks and one or more SMS capable systems associated with the matched consumers.

As another specific illustrative example, in one embodiment, assume a merchant/product/service type-to-event type mapping system is created at CREATE A MERCHANT/PRODUCT/SERVICE TYPE-TO-EVENT TYPE MAPPING SYSTEM OPERATION 203/303 that maps a merchant whose products description include the keywords “fine dining” and “dinner” with events such as “Valentine's Day” or “Thanksgiving”.

In this specific illustrative example, assume events data is obtained at OBTAIN EVENTS DATA FROM ONE OR MORE SOURCES OPERATION 205/303 that indicates a Valentine's day is scheduled for Monday, February 14.

In this specific illustrative example, assume a merchant is the owner of a restaurant and submits the following offer data via SMS at OBTAIN OFFER DATA FROM A MERCHANT OPERATION 207/307:
Item: dinner
Offer: 10% off

In this specific illustrative example, the offer data keyword “dinner” would be mapped to the events including “Valentine's day” and “Thanksgiving” using the merchant/product/service type-to-event type mapping system at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209/309.

In this specific example, the events data is searched to identify a relevant event, i.e., “Valentine's Day” represented by the events data that is of the event type mapped to the offer data.

In this specific example, the offer data, i.e., the keyword “dinner”, and the portion of the events data representing the identified relevant event, i.e., “Valentine's Day” and Monday, February 14, is “matched” at MATCH THE OFFER DATA TO AT LEAST PART OF THE EVENTS DATA REPRESENTING A MATCHED EVENT OF ONE OF THE MAPPED EVENT TYPES OPERATION 211/311.

In this specific example, the matched offer data and relevant event data is automatically transformed into one or more event relevant marketing devices that include at least part of the matched offer data and at least part of the matched relevant event data at AUTOMATICALLY GENERATE ONE OR MORE MARKETING DEVICES INCLUDING THE OFFER DATA MATCHED TO THE EVENT OPERATION 213/313. In this specific example, the one or more event relevant marketing devices could include the following event relevant marketing devices:
1. This Valentine's day enjoy a quite dinner with family at Nandinis @ 10% off on the bill.
2. This Monday have a blast @ Nandinis, get 10% discount on showing student ID card.

In this specific example, the merchant would choose one of the event relevant marketing devices above for distribution.

In one embodiment, in this specific example, consumers' profile data of OBTAIN CONSUMER PROFILE DATA ASSOCIATED WITH ONE OR MORE CONSUMERS OPERATION 315 is searched to find matches between one or more consumers' profile data and the matched offer data and/or matched relevant event data at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317. For instance, the consumers' profile data could be searched for keywords such as “married” or “engaged”. In this specific example, assume two or more consumers are matched to the keywords “married” and “engaged”. Then these consumers are identified as matched consumers.

In one embodiment, the selected event relevant marketing device is then distributed to the identified matched consumers at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319. In this specific example, the event relevant marketing device is then distributed on Monday, February 7, to allow the consumers time to make a reservation. In this specific example, the selected/approved event relevant marketing device is distributed to the matched consumers via a Short Message Service (SMS) message sent via one or more SMS capable communications networks and one or more SMS capable systems associated with the matched consumers.

As another specific illustrative example, in one embodiment, assume a merchant/product/service type-to-event type mapping system is created at CREATE A MERCHANT/PRODUCT/SERVICE TYPE-TO-EVENT TYPE MAPPING SYSTEM OPERATION 203/303 that maps a merchant whose products description include the keywords “jaggery” and “sesame” with the event “Sankranthi”, a festival celebrated in India.

In this specific illustrative example, assume events data is obtained at OBTAIN EVENTS DATA FROM ONE OR MORE SOURCES OPERATION 205/303 that indicates “Sankranthi” is scheduled for Jan. 14, 2011.

In this specific illustrative example, assume a merchant sells “jaggery” and “sesame” and submits the following offer data via SMS at OBTAIN OFFER DATA FROM A MERCHANT OPERATION 207/307, in English:
Item: jaggery, sesame
Offer: 10%

In this specific illustrative example, the offer data keywords “jaggery” and “sesame” would be mapped to the events including “India”, and/or “Festival”, and/or “Sankranthi” using the merchant/product/service type-to-event type mapping system at MAP THE OFFER DATA TO ONE OR MORE TYPES OF EVENTS USING THE MERCHANT/PRODUCT/SERVICE TYPE-TO-EVENT TYPE MAPPING SYSTEM OPERATION 209/309.

In this specific example, the events data is searched to identify a relevant event, i.e., “Sankranthi” represented by the events data that is of the event type mapped to the offer data.

In this specific example, the offer data, i.e., the keywords “jaggery” and “sesame”, and the portion of the events data representing the identified relevant event, i.e., “Sankranthi” and Jan. 14, 2011, is “matched” at MATCH THE OFFER DATA TO AT LEAST PART OF THE EVENTS DATA REPRESENTING A MATCHED EVENT OF ONE OF THE MAPPED EVENT TYPES OPERATION 211/311.

In this specific example, the matched offer data and relevant event data is automatically transformed into one or more event relevant marketing devices that include at least part of the matched offer data and at least part of the matched relevant event data at AUTOMATICALLY GENERATE ONE OR MORE MARKETING DEVICES INCLUDING THE OFFER DATA MATCHED TO THE EVENT OPERATION 213/313. However, in this specific example, even though the offer data was submitted in English, since the Sankranthi festival is celebrated in India, the relevant marketing devices are generated in Hindi and, in this specific example, the one or more event relevant marketing devices could include the following event relevant marketing devices:
nimma sankrantiyannu kushiyinda aacharisi! yellu bellada mele 10% riyAyiti paDeyiri.
Telugu: meeru sankrantini santoshanga jarupukodAniki meeku nuvvulu mariyu bellam pai 10% riyAyiti poNdanDi.

In this specific example, the merchant would choose one of the event relevant marketing devices above for distribution.

In one embodiment, in this specific example, consumers' profile data of OBTAIN CONSUMER PROFILE DATA ASSOCIATED WITH ONE OR MORE CONSUMERS OPERATION 315 is searched to find matches between one or more consumers' profile data and the matched offer data and/or matched relevant event data. For instance, the consumers' profile data could be searched for keywords such as “India” or “Indian” or “Hindi” or “Hindu”. In this specific example, assume two or more consumers are matched to the keywords “India” and “Hindi”. Then these consumers are identified as matched consumers at MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317.

In one embodiment, the selected event relevant marketing device is then distributed to the identified matched consumers at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319. In this specific example, the event relevant marketing device is then distributed on January 13 and 14, to serve the dual purposes of reminding the consumers about the offer and the festival. In this specific example, the selected/approved event relevant marketing device is distributed to the matched consumers via a Short Message Service (SMS) message sent via one or more SMS capable communications networks and one or more SMS capable systems associated with the matched consumers.

In one embodiment, once the selected/approved one or more event relevant marketing devices of AUTOMATICALLY GENERATE ONE OR MORE MARKETING DEVICES INCLUDING THE OFFER DATA MATCHED TO THE EVENT OPERATION 313 are distributed to matched one or more consumers of MATCH THE MATCHED EVENT OF THE ONE OR MORE MARKETING DEVICES TO CONSUMER PROFILE DATA OF ONE OF MORE MATCHED CONSUMERS OF THE ONE OR MORE CONSUMERS OPERATION 317, in one embodiment, at a time calculated to correlate with the matched relevant event of MATCH THE OFFER DATA TO AT LEAST PART OF THE EVENTS DATA REPRESENTING A MATCHED EVENT OF ONE OF THE MAPPED EVENT TYPES OPERATION 311 at SEND AT LEAST ONE OF THE ONE OR MORE MARKETING DEVICES TO THE ONE OR MORE MATCHED CONSUMERS AT A TIME ASSOCIATED WITH THE MATCHED EVENT OPERATION 319, process flow proceeds to EXIT OPERATION 331.

In one embodiment at EXIT OPERATION 331 process for automatically generating event relevant marketing devices 200 is exited to await new data.

Using process for automatically generating event relevant marketing devices 300, in response to a user merchant providing only a minimal amount of data, i.e., the offer data, one or more event relevant marketing devices are automatically generated, and sent to relevant consumers, on behalf of the user merchant.

This is possible because, in one embodiment: the determination of what events are coming up in one or more areas/regions associated with the merchant's business; the determination of which of the upcoming events are logically related, or relevant, to the merchant's products and/or services and/or the offer of the marketing device; the creation of the actual marketing device wording and ensuring the marketing device wording meets any formatting requirements for one or more distribution mechanisms, such as SMS character limits and formatting, in one or more languages; the translation of the marketing device, if necessary, into one or more languages associated with the areas where the determined relevant events are taking place; the tracking of the dates and/or times of the determined relevant events; the determination of the best time to distribute the marketing devices to correlate the marketing devices to the dates and/or times of the determined relevant events; and the determination of what consumers might be involved with, affected by, and/or interested in, the determined relevant events, is performed automatically by process for automatically generating event relevant marketing devices 300 in the background and then the generated marketing devices are automatically distributed one or more consumers in a timely manner.

Therefore, using process for automatically generating event relevant marketing devices 300, more merchants, and particularly more small business owners/operators, will be able to distribute event relevant marketing devices thereby providing both merchants and consumers the opportunity to use highly relevant marketing devices at times when they will be of most use to the consumer.

In the discussion above, certain aspects of one embodiment include process steps or operations or instructions described herein for illustrative purposes in a particular order or grouping. However, the particular order or grouping shown and discussed herein is illustrative only and not limiting. Those of skill in the art will recognize that other orders or grouping of the process steps or operations or instructions are possible and, in some embodiments, one or more of the process steps or operations or instructions discussed above can be combined or deleted. In addition, portions of one or more of the process steps or operations or instructions can be re-grouped as portions of one or more other of the process steps or operations or instructions discussed herein. Consequently, the particular order or grouping of the process steps or operations or instructions discussed herein does not limit the scope of the invention as claimed below.

As discussed in more detail above, using the above embodiments, with little or no modification and/or consumer input, there is considerable flexibility, adaptability, and opportunity for customization to meet the specific needs of various consumers under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as “mapping”, “sending”, “identifying”, “determining”, “obtaining”, “monitoring”, “matching”, “updating”, “matching”, “associating”, “analyzing”, “defining”, “storing”, “saving”, “displaying”, “categorizing”, “providing”, “processing”, “accessing”, “selecting”, “creating”, “using”, “submitting”, “generating”, etc., refer to the action and process of a computing system or similar electronic device that manipulates and operates on data represented as physical (electronic) quantities within the computing system memories, resisters, caches or other information storage, transmission or display devices.

Certain aspects of the present invention include process steps or operations and instructions described herein in an algorithmic or algorithmic-like form. It should be noted that the process steps or operations and instructions of the present invention can be embodied in software, firmware, or hardware, and when embodied in software, can be downloaded to reside on and be operated from different platforms used by real time network operating systems.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as defined herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented process for automatically generating event relevant marketing devices comprising:
using one or more processors associated with one or more computing systems to obtain events data from one or more sources of events data;
using one or more processors associated with one or more computing systems to obtain offer data from a merchant;
using one or more processors associated with one or more computing systems to match at least part of the events data to at least part of the offer data;
using one or more processors associated with one or more computing systems to automatically transform at least part of the matched events data and offer data into an at least one event relevant marketing device; and
using one or more processors associated with one or more computing systems to distribute the at least one event relevant marketing device to one or more consumers.

2. The computing system implemented process for automatically generating event relevant marketing devices of claim 1, wherein;
at least part of the events data is selected from the group of events data consisting of:
locations, dates, and times associated with religious holidays;
locations, dates, and times associated with religious festivals;
locations, dates, and times associated with secular holidays;
locations, dates, and times associated with secular festivals;
locations, dates, and times associated with regional holidays;
locations, dates, and times associated with regional festivals;
locations, dates, and times associated with sporting matches;
locations, dates, and times associated with races; and
locations, dates, and times associated with other entertainment-based engagements.

3. The computing system implemented process for automatically generating event relevant marketing devices of claim 1, wherein;
at least one of the sources of events data is selected from the group of sources of events data consisting of:
local, regional, and/or national calendars;
religious calendars;
local and regional newspapers and other printed media;
local, regional and/or government sources;
sporting organizations and/or sporting organization calendars;
one or more sports teams and/or team calendars;
local, regional, and/or national radio and/or TV stations;
local, regional, and/or national web-sites;
the Internet;
blogs and/or social media sites;
subscription services; and
one or more subscriber.

4. The computing system implemented process for automatically generating event relevant marketing devices of claim 1, wherein;
at least part of the offer data is selected from the group of offer data consisting of:
the name of the merchant and/or the merchant's business;
the products sold by the merchant and/or the merchant's business;
the services provided by the merchant and/or the merchant's business;
the products and/or services that are the subject of the offer data;
the terms of the offer;
any conditions of the offer; and
any events or events types the merchant feels are good candidates to link with the offer data.

5. The computing system implemented process for automatically generating event relevant marketing devices of claim 1, wherein;
at least part of the events data is matched to at least part of the offer data using a merchant/product/service type-to-event type mapping system that matches merchants, and/or services offered by merchants, and/or products offered by merchants, to types of events that are potentially related to, and/or are associated with, and/or logically connected to, the merchants, services, and/or products.

6. The computing system implemented process for automatically generating event relevant marketing devices of claim 1, wherein;
the at least one event relevant marketing device is distributed to the one or more consumers via an SMS Short Message Service (SMS) message.

7. A computing system implemented process for automatically generating event relevant marketing devices comprising:
using one or more processors associated with one or more computing systems to obtain events data from one or more sources of events data;
using one or more processors associated with one or more computing systems to obtain offer data from a merchant;
using one or more processors associated with one or more computing systems to obtain consumer profile data associated with one or more consumers;
using one or more processors associated with one or more computing systems to match at least part of the events data to at least part of the offer data;
using one or more processors associated with one or more computing systems to automatically transform at least part of the matched events data and offer data into an at least one event relevant marketing device;
using one or more processors associated with one or more computing systems to match at least part of the matched events data and offer data of the at least one event relevant marketing device to at least part of the consumer profile data associated with one or more matched consumers of the one or more consumers; and
using one or more processors associated with one or more computing systems to distribute the at least one event relevant marketing device to the one or more matched consumers.

8. The computing system implemented process for automatically generating event relevant marketing devices of claim 7, wherein;
at least part of the events data is selected from the group of events data consisting of:
locations, dates, and times associated with religious holidays;
locations, dates, and times associated with religious festivals;
locations, dates, and times associated with secular holidays;
locations, dates, and times associated with secular festivals;
locations, dates, and times associated with regional holidays;
locations, dates, and times associated with regional festivals;
locations, dates, and times associated with sporting matches;
locations, dates, and times associated with races; and
locations, dates, and times associated with other entertainment-based engagements.

9. The computing system implemented process for automatically generating event relevant marketing devices of claim 7, wherein;
at least one of the sources of events data is selected from the group of sources of events data consisting of:
local, regional, and/or national calendars;
religious calendars;
local and regional newspapers and other printed media;
local, regional and/or government sources;
sporting organizations and/or sporting organization calendars;
one or more sports teams and/or team calendars;
local, regional, and/or national radio and/or TV stations;
local, regional, and/or national web-sites;
the Internet;
blogs and/or social media sites;
subscription services; and
one or more subscriber.

10. The computing system implemented process for automatically generating event relevant marketing devices of claim 7, wherein;
at least part of the offer data is selected from the group of offer data consisting of:
the name of the merchant and/or the merchant's business;
the products sold by the merchant and/or the merchant's business;
the services provided by the merchant and/or the merchant's business;
the products and/or services that are the subject of the offer data;
the terms of the offer;
any conditions of the offer; and
any events or events types the merchant feels are good candidates to link with the offer data.

11. The computing system implemented process for automatically generating event relevant marketing devices of claim 7, wherein;
wherein at least part of the consumer profile data is selected from the group of consumer profile data consisting of:
general demographic data associated with the consumer;
the consumer's region of residence;
the consumer's area of employment;
the consumer's sex;
the consumer's religious beliefs/affiliations;
the consumer's hobbies and/or interests;
sports played/followed by the consumer;
the consumer's entertainment preferences;
the consumer's age;
the consumer's occupation;
the consumer's marital status; and
the consumer's number of dependents.

12. The computing system implemented process for automatically generating event relevant marketing devices of claim 7, wherein;
wherein at least part of the consumer profile data is obtained from a source of consumer profile data selected from the group of sources of consumer profile data consisting of:
the consumers themselves;
computing systems associated with the consumers;
mobile computing systems associated with the consumers;
data collected by monitoring a consumer's historical usage of marketing devices; and
data collected by monitoring a consumer's historical usage of event relevant marketing devices distributed to the consumers by the computing system implemented process for automatically generating event relevant marketing devices.

13. The computing system implemented process for automatically generating event relevant marketing devices of claim 7, wherein;
at least part of the events data is matched to at least part of the offer data using a merchant/product/service type-to-event type mapping system that matches merchants, and/or services offered by merchants, and/or products offered by merchants, to types of events that are potentially related to, and/or are associated with, and/or logically connected to, the merchants, services, and/or products.

14. The computing system implemented process for automatically generating event relevant marketing devices of claim 7, wherein;
the at least one event relevant marketing device is distributed to the one or more consumers via an SMS Short Message Service (SMS) message.

15. A system for automatically generating event relevant marketing devices comprising:
a merchant computing system accessible by a merchant;
offer data stored in a storage means, at least part of the offer data having been obtained from the merchant thorough the merchant computing system;
a consumer computing system accessible by a consumer;
events data stored in a storage means;
a merchant/product/service type-to-event type mapping system that matches merchants, and/or services offered by merchants, and/or products offered by merchants, to types of events that are potentially related to, and/or are associated with, and/or logically connected to, the merchants, services, and/or products; and
a marketing device server, the marketing device server including one or more processors associated with one or more computing systems for implementing at least a portion of a process for automatically generating event relevant marketing devices, the process for automatically generating event relevant marketing devices comprising:
using the one or more processors associated with the marketing device server and the merchant/product/service type-to-event type mapping system to match at least part of the events data to at least part of the offer data;
using the one or more processors associated with the marketing device server to automatically transform at least part of the matched events data and offer data into an at least one event relevant marketing device; and
using the one or more processors associated with the marketing device server to distribute the at least one event relevant marketing device to the consumer computing system.

16. The system for automatically generating event relevant marketing devices of claim 15, wherein;
at least part of the events data is selected from the group of events data consisting of:
locations, dates, and times associated with religious holidays;
locations, dates, and times associated with religious festivals;
locations, dates, and times associated with secular holidays;
locations, dates, and times associated with secular festivals;
locations, dates, and times associated with regional holidays;
locations, dates, and times associated with regional festivals;
locations, dates, and times associated with sporting matches;
locations, dates, and times associated with races; and
locations, dates, and times associated with other entertainment-based engagements.

17. The system for automatically generating event relevant marketing devices of claim 15, wherein;
at least one of the sources of the events data is selected from the group of sources of events data consisting of:
local, regional, and/or national calendars;
religious calendars;
local and regional newspapers and other printed media;
local, regional and/or government sources;
sporting organizations and/or sporting organization calendars;
one or more sports teams and/or team calendars;
local, regional, and/or national radio and/or TV stations;
local, regional, and/or national web-sites;
the Internet;
blogs and/or social media sites;
subscription services; and
one or more subscriber.

18. The system for automatically generating event relevant marketing devices of claim 15, wherein;
at least part of the offer data is selected from the group of offer data consisting of:
the name of the merchant and/or the merchant's business;
the products sold by the merchant and/or the merchant's business;
the services provided by the merchant and/or the merchant's business;
the products and/or services that are the subject of the offer data;
the terms of the offer;
any conditions of the offer; and
any events or events types the merchant feels are good candidates to link with the offer data.

19. The system for automatically generating event relevant marketing devices of claim 15, wherein;
the at least one event relevant marketing device is distributed to the consumer computing system via an SMS Short Message Service (SMS) message.

20. A system for automatically generating event relevant marketing devices comprising:
a merchant computing system accessible by a merchant;
offer data stored in a storage means, at least part of the offer data having been obtained from the merchant thorough the merchant computing system;
one or more consumer computing systems accessible by one or more consumers;
events data stored in a storage means;
consumer profile data associated with one or more consumers stored in a storage means;
a merchant/product/service type-to-event type mapping system that matches merchants, and/or services offered by merchants, and/or products offered by merchants, to types of events that are potentially related to, and/or are associated with, and/or logically connected to, the merchants, services, and/or products; and
a marketing device server, the marketing device server including one or more processors associated with one or more computing systems for implementing at least a portion of a process for automatically generating event relevant marketing devices, the process for automatically generating event relevant marketing devices comprising:
using the one or more processors associated with the marketing device server and the merchant/product/service type-to-event type mapping system to match at least part of the events data to at least part of the offer data;
using the one or more processors associated with the marketing device server to automatically transform at least part of the matched events data and offer data into an at least one event relevant marketing device;
using the one or more processors associated with the marketing device server to match at least part of the matched events data and offer data of the at least one event relevant marketing device to at least part of the consumer profile data associated with one or more matched consumers of the one or more consumers; and
using the one or more processors associated with the marketing device server to distribute the at least one event relevant marketing device to the one or more consumer computing systems associated with the one or more matched consumers.

21. The system for automatically generating event relevant marketing devices of claim 20, wherein;
at least part of the events data is selected from the group of events data consisting of:
locations, dates, and times associated with religious holidays;
locations, dates, and times associated with religious festivals;
locations, dates, and times associated with secular holidays;
locations, dates, and times associated with secular festivals;
locations, dates, and times associated with regional holidays;
locations, dates, and times associated with regional festivals;
locations, dates, and times associated with sporting matches;
locations, dates, and times associated with races; and
locations, dates, and times associated with other entertainment-based engagements.

22. The system for automatically generating event relevant marketing devices of claim 20, wherein;
at least one of the sources of events data is selected from the group of sources of events data consisting of:
local, regional, and/or national calendars;
religious calendars;
local and regional newspapers and other printed media;
local, regional and/or government sources;
sporting organizations and/or sporting organization calendars;
one or more sports teams and/or team calendars;
local, regional, and/or national radio and/or TV stations;
local, regional, and/or national web-sites;
the Internet;
blogs and/or social media sites;
subscription services; and
one or more subscriber.

23. The system for automatically generating event relevant marketing devices of claim 20, wherein;
at least part of the offer data is selected from the group of offer data consisting of:
the name of the merchant and/or the merchant's business;
the products sold by the merchant and/or the merchant's business;
the services provided by the merchant and/or the merchant's business;
the products and/or services that are the subject of the offer data;
the terms of the offer;
any conditions of the offer; and
any events or events types the merchant feels are good candidates to link with the offer data.

24. The system for automatically generating event relevant marketing devices of claim 20, wherein;
wherein at least part of the consumer profile data is selected from the group of consumer profile data consisting of:
general demographic data associated with the consumer;
the consumer's region of residence;
the consumer's area of employment;
the consumer's sex;
the consumer's religious beliefs/affiliations;
the consumer's hobbies and/or interests;
sports played/followed by the consumer;
the consumer's entertainment preferences;
the consumer's age;
the consumer's occupation;
the consumer's marital status; and
the consumer's number of dependents.

25. The system for automatically generating event relevant marketing devices of claim 20, wherein;
wherein at least part of the consumer profile data is obtained from a source of consumer profile data selected from the group of sources of consumer profile data consisting of:
the consumers themselves;
computing systems associated with the consumers;
mobile computing systems associated with the consumers;
data collected by monitoring a consumer's historical usage of marketing devices; and
data collected by monitoring a consumer's historical usage of event relevant marketing devices distributed to the consumers by the computing system implemented process for automatically generating event relevant marketing devices.

26. The system for automatically generating event relevant marketing devices of claim 20, wherein;
the at least one event relevant marketing device is distributed to the one or more consumers via an SMS Short Message Service (SMS) message.
